(19) United States
(12) Patent Application Publication
(10) Pub. No.: US 2005/0210144 A1
(43) Pub. Date: Sep. 22, 2005

(54) Load balancing method and system

(76) Inventors: Atsuya Kumagai, Kawasaki (JP); Kenta Shiga, Yokohama (JP); Naoko Iwami, Sagamihara (JP); Kiyoshi Honda, Yokohama (JP)

Correspondence Address: MATTINGLY, STANGER & MALUR, P.C.;ATTORNEYS AT LAW, SUITE 370, 1800 DIAGONAL ROAD, ALEXANDRIA, VA, 22314, US

(21) Appl. No.: 10/845,121

(22) Filed: May 14, 2004

(30) Foreign Application Priority Data
Mar. 18, 2004 (JP) 2004-077819

(51) Int. Cl. G06F 15/16; G06F 15/173

(52) U.S. Cl. 709/229; 709/225

(57) ABSTRACT

A load balancing method includes a measurement step of measuring reception loads of respective storage ports 301 provided in a storage system 300; an allocation changing step of changing a transmitting rate of a computer port 208 provided in a computer 200, which is allocated for each of the storage ports, on the basis of the reception loads of the respective storage ports 301 measured in the measurement step; and a transmission step of transmitting data to the respective storage ports 301 of the storage system 300 at a transmitting rate in a range not exceeding the transmitting rate for each of the storage ports 301 changed in the allocation changing step.

### BACKGROUND OF THE INVENTION

The present invention relates to a technique for load balance in a computer system, and in particular to a technique for load balance of ports in a storage system.

Japanese Patent Laid-open Publication No. H7-334449 (hereinafter referred to as Patent Document 1) discloses a technique for performing load balance of ports in a storage system including plural ports. In other words, loads at the respective ports in the storage system are measured, and a port with a low load is selected on the basis of a result of the measurement to input and output data.

### SUMMARY OF THE INVENTION

Incidentally, as a SAN (Storage Area Network) in which a server and a storage system, are connected by a dedicated network, an FC SAN, in which a SAN is constituted by a fiber channel, has been mainly used. However, recently, an IP SAN, in which a SAN is constituted by an IP (Internet Protocol) network is being widespread. The IP SAN has advantages compared with the FC SAN. for example, the IP SAN can be realized at lower cost than the FC SAN.

In addition, in the IF, data is sent and received by a unit of packet by adding an IP header including information such as an IP address to a TCP (Transmission Control Protocol) segment to be described later. Then, the packer is relayed by a forwarding device and sent to a destination. If a large number of packets simultaneously center on a path to the destination and congestion occurs, the packet is discarded. Then, a function for resending the discarded packet is provided by the TCP. Note that the congestion means that relay and transmission of a packet cannot be performed due to generation of a packet exceeding a processing capability of a forwarding device or a reception side.

In the TCP, data is sent and received by establishing a TCP connection between a sender TCP port and a destination TCP port and adding a TCP header including information such as a port number to data to create a TCP segment. In addition, in the TCP, the reception side transmits a response of acknowledgement to the sender when the data is received. If there is no response of acknowledgement from the reception side for a fixed time, the sender judges that congestion has occurred, reduces a window size, and resends the TCP segment for which a response of acknowledgment has not been received. Note that the window size is the number of bytes which the sender can transmit without a response of acknowledgment from the reception side. It is likely that continuous decline in a throughput is caused by the reduction of the window size. As a protocol for realizing the IP SAN on the basis of such a TCP/IP, there is an iSCSI (internet Small Computer System Interface). In the iSCSI protocol, an SCSI command and data are sent and received between a server and a storage system.

However, the technique disclosed in the Patent Document 1 is a load balancing technique for a computer system which performs input/output of data via a bus. Therefore, the Patent Document 1 does not take into consideration the decline in a throughput due to reduction in the window size of the TCP which is caused by occurrence of congestion in a port of the storage system on the reception side in the case such an IP SAN is realized.

In addition, full duplex communication is typical in the IP SAN, and loads of Transmission and reception can be treated independently. However, in the Patent Document 1, loads of ports are measured without distinction of transmission and reception. Thus, in the Parent Document 1, in the case in which a reception load of a port of the storage system is high, the port cannot be utilized for transmission effectively even if a transmission load is low. Similarly, in the Patent Document 1, in the case in which a transmission load of a port of the storage system is high, the port cannot be utilized for reception effectively even if a reception load is low.

In order to solve the above-mentioned problems, in the present invention, in a computer system including: a computer; a storage system which stores data to be accessed by the computer via a network; and a management apparatus which manages the computer and the storage system, loads of storage ports provided in the storage system are distributed.

For example, a load balancing method of the present invention includes: a measurement step of measuring reception loads of respective storage ports provided in a storage system; an allocation changing step of changing a transmitting rate of a computer port provided in a computer, which is allocated to each of the storage ports, on the basis of the reception loads of the respective storage ports measured in the measurement step; and a transmission step of transmitting data to the respective storage ports of the storage system at a transmitting rate in a range not exceeding the transmitting rate for each of the storage ports changed in the allocation changing step.

### BRIEF DESCRIPTION OF THE DRAWINGS

FIG. 1 is a schematic diagram of a computer system to which a first embodiment is applied;

FIG. 2 is a diagram showing an example of programs and data retained in a memory of a server;

FIG. 3 is a diagram showing an example of transmitting rate information retained in the memory of the server;

FIG. 4 is a diagram showing an example of programs and data retained in a memory of a storage system;

FIG. 5 is a diagram showing an example of system information retained in the memory of the storage system;

FIG. 6 is a diagram showing an example of load information retained in the memory of the storage system;

FIG. 7 is a diagram showing an example of programs and data retained in a memory or an operation management apparatus;

FIG. 8 is a diagram showing an example of management information retained in the memory of the operation management apparatus;

FIG. 9 is a flow diagram of write processing of the server;

FIG. 10 is a flow diagram of load measurement processing of the server;

FIG. 11 is a flow diagram of load measurement processing of the storage system;

FIG. 12 is a flow diagram of transmitting rate change processing of the storage system;

FIG. 13 is a flow diagram of transmitting rate change processing or the operation management apparatus;

FIG. 14 is a flow diagram of transmitting rate change processing of the operation management apparatus:

FIG. 15 is a flow diagram of transmitting rate change processing of the storage system;

FIG. 16 is a flow diagram of transmitting rate charge processing of the operation management apparatus:

FIG. 17 is a flow diagram of transmitting rate allocation processing of a server in a second embodiment;

FIG. 18 is a flow diagram of transmitting rate allocation processing of a operation management apparatus;

FIG. 19 is a flow diagram of transmitting rate allocation request processing of a storage system in a third embodiment;

FIG. 20 is a schematic diagram of a computer system to which a fourth embodiment is applied;

FIG. 21 is a diagram showing an example of programs and data retained in a memory of a source storage system;

FIG. 22 is a flow diagram of initialization processing in an operation management apparatus; and

FIG. 23 is a flow diagram of initialization processing in a server.

### DESCRIPTION OF THE PREFERRED EMBODIMENTS

Now, the Computer systems, to which embodiments of the present invention are applied, will be hereinafter described.

In a first embodiment, a case in which servers 200 writes data in a storage system 300 using an iSCSI protocol will be described as an example. Note that the iSCSI protocol is a protocol for transmitting and receiving an SCSI command (a write request or a read request) and data, which are used for communication between a storage unit and a computer, through an IP network. In the iSCSI protocol, the computer system is constituted by iSCSI initiators which issue the SCSI command to request processing, and iSCSI targets which perform the processing. In this embodiment, the servers 200 include the iSCSI initiators, and the storage system 300 includes the iSCSI targets.

In addition, in the iSCSI protocol, the SCSI command and the data are subjected to encapsulation processing to create an iSCSI PDU (Protocol Data Unit). The iSCSI PDU is a unit of data to be treated by the iSCSI protocol. Further, in the iSCSI protocol, the iSCSI PDU is divided into several packets and sent via a TCP connection provided by a TCP/IP. Moreover, in the iSCSI protocol, processing for receiving a packet via the TCP connection, generating the iSCSI PDU from the received packet, and extracting the SCSI command and the data from the iSCSI PDU is performed. Note that, the iSCSI PDU, there are an iSCSI PDU of a request message which includes an SCSI command and data, and an iSCSI PDU which includes only data.

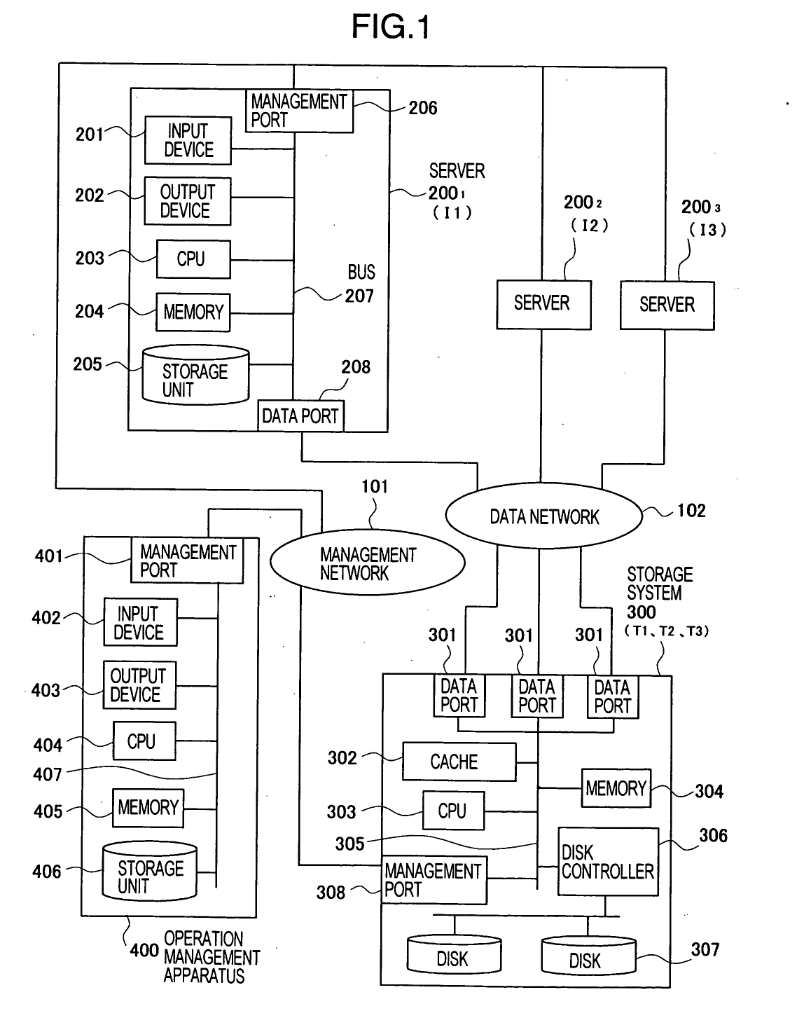

FIG. 1 is a schematic diagram of a computer system to which the first embodiment is applied. As shown in the figure, the computer system of this embodiment includes the plural servers 200, the storage system 300, and an operation management apparatus 400. The plural servers 200 and the storage system 300 are connected to each other via a data network 102 which is an IP network such as the internet. In addition, the servers 200 and the storage system 300 are connected to the operation management apparatus 400 via a management network 101 which is an IP network such as the Internet. Note that, in the illustrated embodiment, the management network 101 and the data network 102 are separate networks. However, these may be integrated as one network. In this case, it is possible to design data ports and management ports as identical ports in the servers 200 and the storage system 300.

The servers 200 are information processing apparatuses which executes an application involving input/output of data. That is, the servers 200 access the storage system 300 via the data network 102 to read and write data in accordance with the iSCSI protocol. Note that, in this embodiment, as described above, it is assumed that the server 200 is an iSCSI initiator and each of the servers 200 has one iSCSI initiator. In order to identify the iSCSI initiators, each of the iSCSI initiators has an iSCSI name. As shown in the figure, it is assumed that the iSCSI name of the server 200₁ is “I1”, the iSCSI name of the server 200₂ is “I2”, and the iSCSI name of the server 200₃ is “I3”.

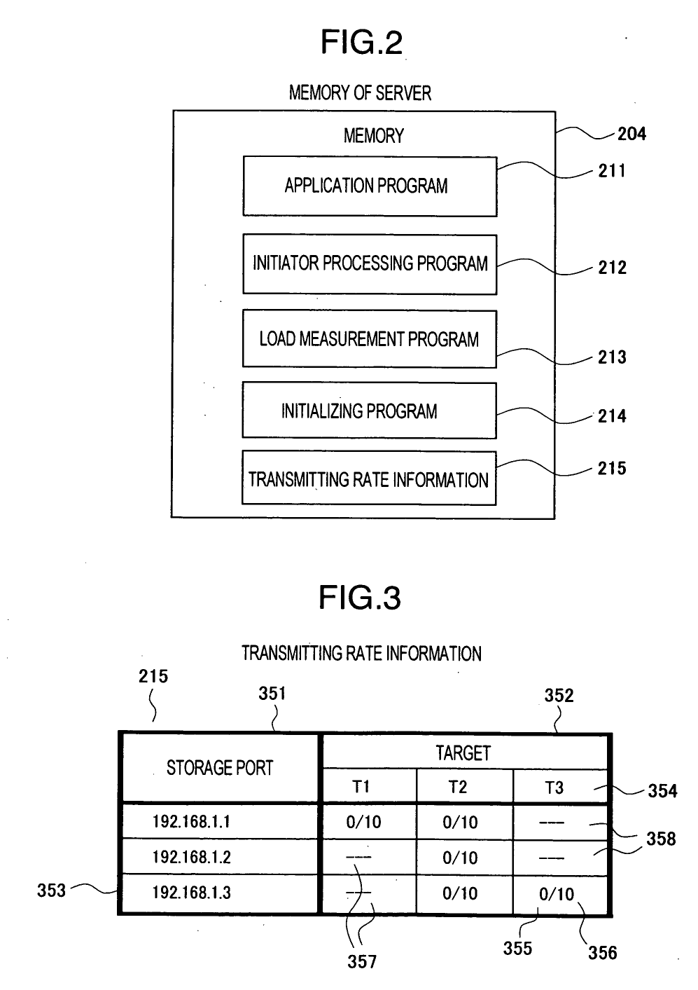

The server 200 includes an input device 201 such as a keyboard or a mouse, an output device 202 such as a display on a printer, a CPU 203, a memory 204, a storage unit 205 such as an HDD, a management server port 206, a data server port 208, and a bus 207 which connects these devices. Programs and data shown in FIG. 2 are stored in the memory 204. The CPU 203 performs various kinds of processing to be described later by executing the programs stored in the memory 204. Programs and data, which are loaded to the memory 204 on startup of the server 200, are stored in the storage unit 205. The management server port 206 is a device for transmitting and receiving packets to and from the operation management apparatus 400 via the management network 101. In addition, the data server port 208 is a device for transmitting and receiving packets, which are obtained by dividing an iSCSI PDU, to and from the storage system 300 via the data network 102.

Note that the illustrated server 200 is only an example, and the present invention is not limited to this. For example, each of the servers 200 may include plural data server ports 208 or may include plural iSCSI initiators.

The storage system 300 has a function as a storage unit for the servers 200 which are connected thereto via the data network 102. Note that, as described above, the storage system 300 includes iSCSI targets. In this embodiment, it is assumed that the storage system 300 includes three iSCSI targets, and iSCSI names for identifying the iSCSI targets are “T1”, “T2” and “T3”.

The storage system 300 includes data storage ports 301, a cache 302 which temporarily stores data in order to speed up access, a CPU 303, a memory 304, a disk controller 306, at least one disk 307, a management storage port 308, and a bus 305 which connects these devices.

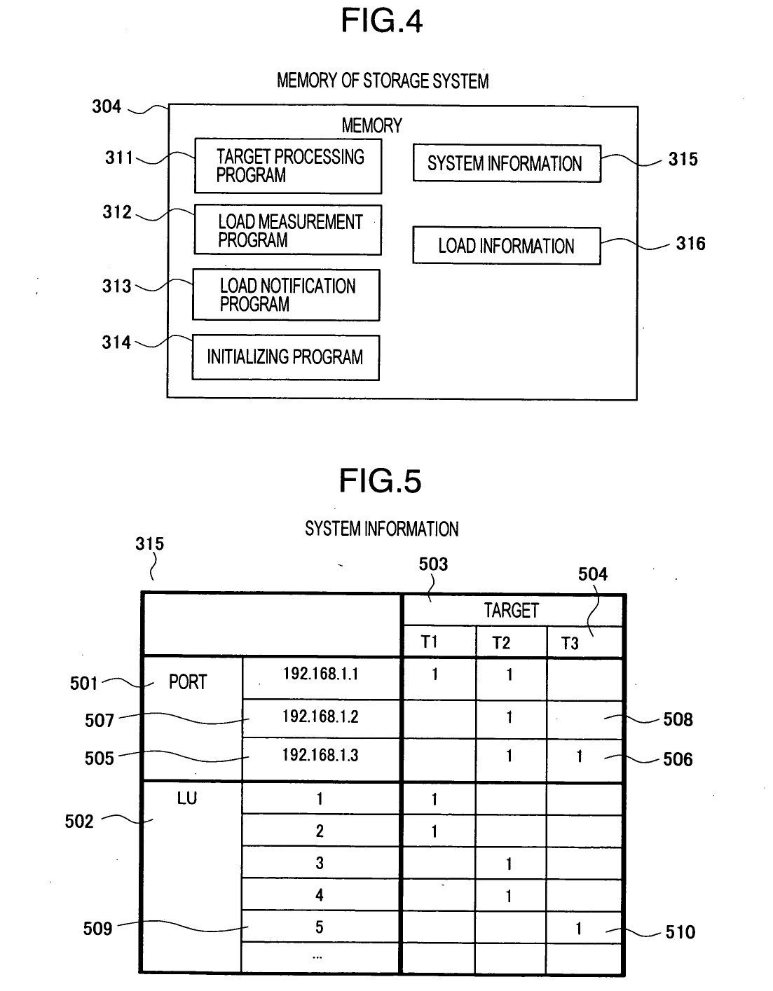

The data storage ports 301 are devices for transmitting and receiving packets, which are obtained by dividing an iSCSI PDU, to and from the servers 200 via the data network 102. The storage system 300 includes at least one data storage port 301, and this data storage port 301 is identified by an IP address. Note that, in this embodiment, it is assumed that the storage system 300 includes three data storage ports 301. Programs and data shown in FIG. 4 are stored in the memory 304. The CPU 303 performs various kinds of processing to be described later by executing the programs stored in the memory 304.

The disk controller 306 is a device which controls input and output of data to and from the disk 307. Note that the disk controller 306 may be a device which performs processing equivalent to that of a RAID (Redundant Array of Independent Disks). Data, which is read and written by the servers 200, and programs and data, which are loaded to the memory 304 on startup of the storage system 300, are stored in the disk 307. The management storage port 308 is a device for transmitting and receiving packets to and from the operation management apparatus 400 via the management network 101. Note that the illustrated storage system 300 is only an example, and the present invention is not limited to this. For example, the storage system 300 may include one or two iSCSI targets or may include four or more iSCSI targets. In addition, the storage system 300 may include one or two dart storage ports 301 or may include four or more data storage ports 301.

Tho operation management apparatus 400 is an apparatus for distributing transmission leads or reception loads of the servers 200 and the storage system 300. The operation management apparatus 400 includes a management port 401, an input device 402 such as a keyboard or a mouse, an output device 403 such as a display or a printer, a CPU 404, a memory 405, a storage unit 406, and a bus 407 which connects these devices.

The management port 401 if a device which transmits and receives packets to and from the servers 200 and the storage system 300 via the management network 101. Programs and data shown in FIG. 7 are stored in the memory 405. The CPU 404 performs various kinds of processing to be described later by executing the program stored in the memory 405. Programs and data, which are loaded in the memory 405 on startup of the servers 200, are stored in the storage unit 406. Note that the illustrated operation management apparatus 400 is an example, and the present invention is not limited to this.

FIG. 2 shows programs and data which ate stored in the memory 204 of the server 200. An application program 211, an initiator processing program 212, a load measurement program 213, an initializing program 214, and transmitting rate information 215 are stored in the memory 204.

The application program 211 is a program for performing predetermined business processing. The initiator processing program 212 is a program for performing processing of the iSCSI protocol. That is, the CPU 203 executes the initiator processing program 212 stored in the memory 204 to thereby perform processing of the iSCSI protocol such as converting write data into a form of an iSCSI PDU of a predetermined length and transmitting an iSCSI PDU of a request message and an iSCSI PDU of data to the storage system 300. In addition, the CPU 203 adjusts an amount of data which the data server port 208 can transmit in a unit time (hereinafter referred to as “transmitting rate”) on the basis of an instruction (notice) of the operation management apparatus 400. Further, the CPU 203 requests the operation management apparatus 400 to allocate the transmitting rate of the data server port 200. Moreover, the CPU 203 defines at least one iSCSI initiator on the basis of an instruction inputted from the input device 402 of the operation management apparatus 400. Note that, in this embodiment, one iSCSI initiator is defined for each of the servers 200.

The load measurement program 213 is a program for measuring an amount of data of transmit data which the data server port 200 sent in a unit time (hereinafter referred to as “transmission load”). The CPU 203 executes the load measurement program 213 stored in the memory 204 to thereby measure the number of bytes of data, which the data server port 208 sent in a unit time, for each of the data storage ports 301 to be used and each destination iSCSI target.

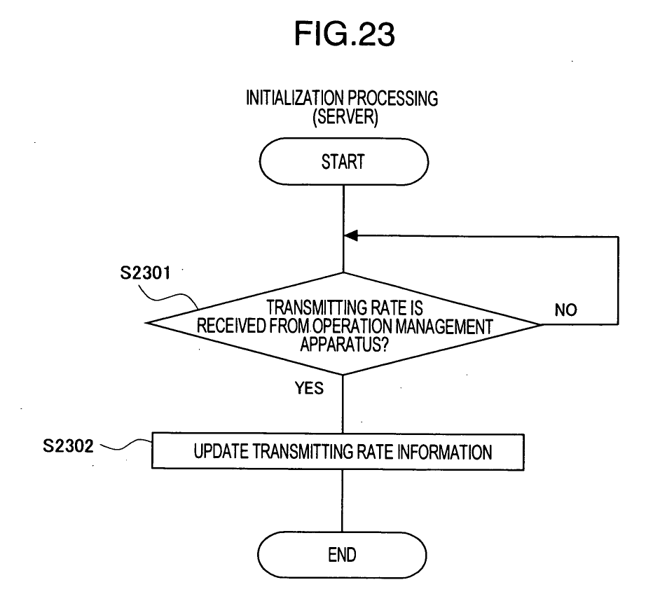

The initializing program 214 is a program for initializing the transmitting rate information 215. The CPU 203 executes the initializing program 214 stored in the memory 204 to thereby set initial values in the transmitting rate information 215 shown in FIG. 3. Note that the CPU 203 executes the initializing program 214 when a power supply is inputted to the server 200 or when a notice of an initial value of a transmitting rate is received from the operation management apparatus 400. In addition, in this embodiment, it is assumed that the CPU 203 sets “0 Mbps (Mega bit per second)” for a transmission load and “10 Mbps” for a transmitting rate as initial values in the transmitting rate information 215. However, the present invention is not limited to this. In addition, processing for receiving a notice of an initial value or a transmitting rate from the operation management apparatus 400 will be illustrated later in FIGS. 22 and 23.

A transmission load and a transmitting rate of the data server port 208 are stored in the transmitting rate information 215. This transmitting rate information 215 is defined in advance with the storage ports 301 and the iSCSI targets, which the iSCSI initiators can use, associated with each other in response to an instruction inputted from the input device 402 of the operation management apparatus 400. This transmitting rate information 215 is defined by the number of the iSCSI initiators included in thc server 200. In this embodiment, the respective servers 200 include one iSCSI initiator. Thus, each of the servers 200 has one transmitting rate information 215.

FIG. 3 shows an example of the transmitting rate information 215. As shown in the figure, the transmitting rate information 215 includes an IP address 351 which identifies the data storage ports 301 of the storage system 300, and an iSCSI name 351 which identifies iSCSI targets which are destinations of write data. A transmission load, which is measured periodically at a fixed time interval, and an allocated transmitting rate are stored for each combination of the IP address 351 and the iSCSI name 352. Note that a numerical value on the left of a cell represents the transmission load, and a numerical value on the right is the transmitting rate. For example, in the case in which data is written in an iSCSI target with the iSCSI name or “T3” 314 using a data storage port 301 with the IP address 351 of “192.168.1.3” 353, the transmission load is “0 Mbps” 355 and the transmitting rate is “10 Mbps” 356. Note that the illustrated transmitting rate information 215 is in a state in which initial values are set. In addition, cells 357 and 358 in which initial values are not set, indicate that data cannot be sent to objective iSCSI targets using the objective storage port 301.

FIG. 4 shows programs and data stored in the memory 304 of the storage system 300. A target processing program 311, a load measurement program 312, a load notification program 313, an initializing program 314, system information 315, and load information 316 are stored in the memory 304.

The target processing program 311 is a program for performing processing of the iSCSI protocol. That is, the CPU 303 executes the target processing program 311 stored in the memory 304 to thereby perform processing of the iSCSI protocol such as transmitting an iSCSI PDU of a response message in response to a request message from the iSCSI initiator of the server 200 and receiving an iSCSI PDU of data. In addition, the CPU 303 requests the operation management apparatus 400 to allocate a transmitting rate of the data server port 208. Further, the CPU 303 defines one or more iSCSI targets and defines system information to be described later (see FIG. 5) on the basis of an instruction inputted from the input device 402 of the operation management apparatus 400.

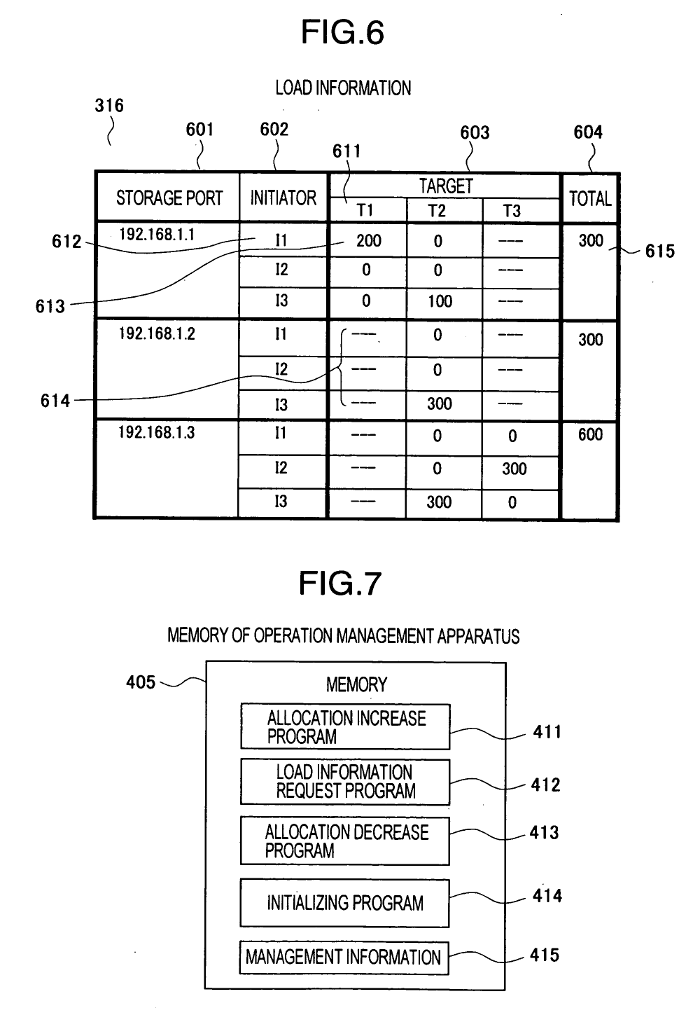

The load measurement program 312 is a program for measuring amounts of data of received data which the respective data storage ports 301 received in a unit time (hereinafter referred to as “reception loads”). The CPU 303 executes the load measurement program 312 stored in the memory 304 to thereby measure the numbers of received bytes per a unit time of the respective data storage ports 301 for each sender iSCSI initiator and each destination iSCSI target. Then, the CPU 303 stores the measured reception load in load information shown in FIG. 6. The load notification program 313 is a program for notifying the operation management apparatus 400 of load information 316 shown in FIG. 6. The CPU 303 executes the load notification program 313 stored in the memory 304 to thereby notify the operation management apparatus 400 of the load information 316.

The initializing program 314 is a program for initializing the load information 316 shown in FIG. 6. The CPU 303 executes the initializing program 314 stored in the memory 304 to thereby set initial values in the load information 316. Note that it is assumed that the CPU 303 executes the initializing program 314 to set all values of the load information 316 to “0” when a power supply is inputted to the storage system 300. However, tho present invention is not limited to this.

Association of the data storage ports 301 and iSCSI targets and association of LUs (Logical Units) and the iSCSI targets are stored in the system information 315. Note that the LUs are units obtained by dividing the disk 307 into plural virtual logical disks.

FIG. 5 shows an example of the system information 315. An IP address 501 for identifying the data storage ports 301 and an LUN (Logical Unit Number) 502 for identifying the LUs are registered (stored) on a vertical axis in the illustrated system information 315. In addition, an iSCSI name 503 for identifying iSCSI targets is registered (stored) on a horizontal axis in the system information 315. In the illustrated system information 315, “1” or a null value (blank) is set in the respective cells where the data storage ports 301 and the iSCSI targets or the LUs and the iSCSI targets cross. In the case in which “1” is set in a cell, it is indicated that the pertinent data storage port 301 (or LU) and the pertinent iSCSI target are associated with each other. In addition, in the case in which the null value (blank) it set in a cell, it is indicated that the pertinent data storage port 301 (or LU) and the pertinent iSCSI target are not associated with each other.

For example, “1” is set in a cell 506 where an iSCSI target “T3” 504 and the data storage port 301 with an IP address “192.168.1.3” 505 cross. Therefore, it is indicated that the iSCSI target “T3” 504 transmits and receives data using the data storage port 301 with the IP address “192.168.1.3” 505. In addition, a null value (blank) 508 is set in a cell 508 where the iSCSI target “T3” 504 and the data storage port 301 with an IP address “192.168.1.2” 507 cross. Therefore, it is indicated that the iSCSI target “T3” 504 cannot transmit and receive data using the data storage port 301 with the IP address “192.168.1.2” 507. Further, “1” is set in a cell 510 where the iSCSI target “T3” 504 and an LU “5” 509 cross. Therefore, it is indicated that the iSCSI target “T3” 504 is associated with the LU “5” 509 and reads data from and writes data in the LU “5” 509, that is, manages input and output for the LU “5” 509.

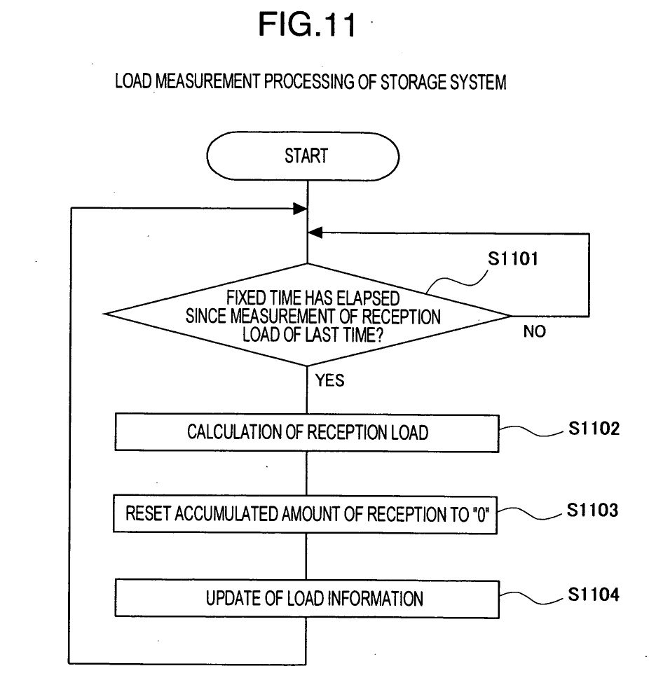

The load information 316 indicates the numbers of received bytes (reception loads) per a unit time of the respective data storage ports 301 measured by the load measurement program 312. This load information 316 is updated at a predetermined time interval by load measurement processing to be described later (see FIG. 11).

FIG. 6 shows an example of the load information 316. The illustrated load information 316 has the number of received bytes (reception load) measured for each combination of an IP address 601 for identifying the data storage port 301, an iSCSI name 602 for identifying a sender iSCSI initiator of data, and an iSCSI name 603 for identifying a destination iSCSI target of the data. In addition, the load information 316 has the total number of received bytes (reception load) 604 per a unit time for each of the data storage ports 301.

In the illustrated load information 316, for example, it is indicated that the number of received bytes per a unit time, which an iSCSI target “T1” 611 received from an iSCSI initiator “I1” 612 in the storage port 301 with an IP address “192.168.1.1”, is “200 Mbps” 613. In addition, a null value (blank) is set in each cell 614 of the iSCSI target “T1” 611 in the storage port 301 with an IF address “192.168.1.2”. It is indicated that, based upon the system information 315 (see FIG. 5), the iSCSI target “T1” 611 is not associated with the storage port 301 with the IP address “192.168.1.2”, that is, the storage port 301 with the IP address “192.168.1.2” cannot be used. In addition, its indicated that the total number of received bytes of the data storage port 301 with the IP address 192.168.1.1 is “300 Mbps” 615.

FIG. 7 shows programs and data which are stored in the memory 405 of the operation management apparatus 400. An allocation increase program 411, a load information request program 412, an allocation decrease program 413, an initializing program 414, and management information 415 are stored in the memory 406. The allocation increase program 411 is a program for increasing transmitting rates allocated to respective iSCSI initiators. The CPU 404 executes the allocation increase program 411 stored in the memory 405 to thereby increase the transmitting rates allocated to the respective iSCSI initiators to a fixed amount.

The load information request program 412 is a program for requesting the storage system 300 to notify the load information 316. The CPU 404 executes the load information request program 412 stored in the memory 405 to thereby acquire the load information 316.

The allocation decrease program 413 is a program for decreasing allocation of a transmitting rate to an iSCSI initiator. The CPU 404 executes the allocation decrease program 413 stored in the memory 405 to thereby decrease a transmitting rate allocated to an iSCSI initiator, which has a small amount of data transmission, for a fixed time.

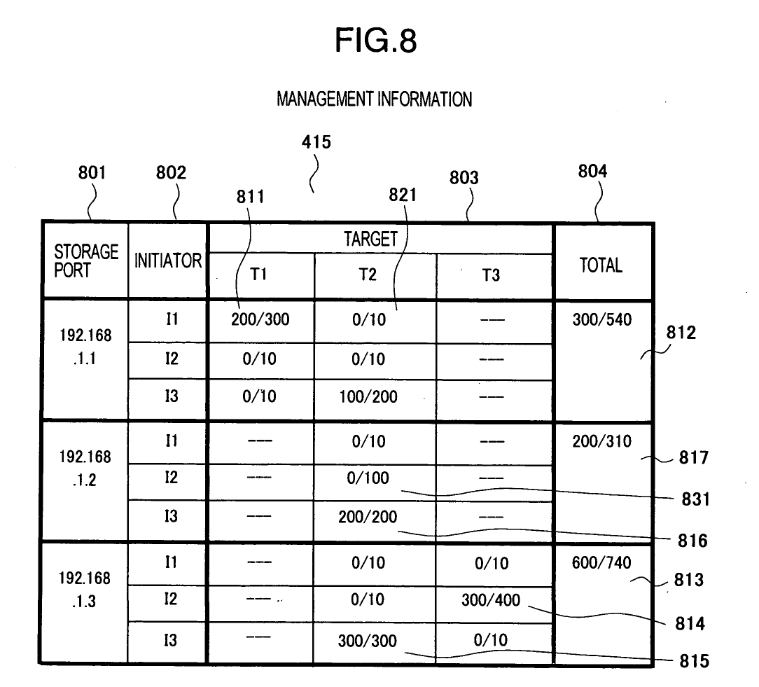

The initializing program 414 is a program for initializing the management information 415 to be described later (see FIG. 8). The CPU 404 executes the initializing program 414 stored in the memory 405 to thereby set initial values in the management information 415. Note that, when a power supply is inputted to the operation management apparatus 400, the CPU 404 sets predetermined initial values which are stored in the disk 307 in advance. Alternatively, the CPU 404 initializes the management information 415 on the basis of initial values inputted from the input device 402 of the operation management apparatus 400. In addition, in the case in which the management information 415 is initialized on the basis of the initial values inputted from the input device 402, the CPU 404 notifies the server 200 of the inputted initial values. Note that processing for receiving notification of an initial value of a transmitting rate from the operation management apparatus 400 will be described later with reference to FIGS. 22 and 23. In addition, in this embodiment, it is assumed that “0 Mbps” is set for the reception load and “10 Mbps” is set for the transmitting rate as the initial values of the management information 415. However, the present invention is not limited to this.

The load information 316 acquired from the storage system 300 and transmitting rates of the servers 200, which are allocated on the basis of this load information 316, are stored in the management information 415.

FIG. 8 shows an example of the management information 415. As shown in the figure, the management information 415 has the number of received bytes (reception load) of the data storage ports 301 and a transmitting rate for the data server port 208 which are measured for each combination of an IP address 801 for identifying the data storage ports 301, an iSCSI name 802 for identifying an iSCSI initiator a sender of data, and an iSCSI name 803 for identifying a destination iSCSI target of the data. In addition, the management information 415 has the total number of received bytes (reception load) 804 per a unit time for each data storage port 301. It is indicated that, in the data storage port 301 with the IP address “192.168.1.1”, in the case in which data is written in the destination iSCSI target “T1” from the sender iSCSI initiator “I1”, a reception load is “200 Mbps” 811, and an allocated transmitting rate is “300 Mbps” 811. In addition, it is indicated that the total number of received bytes of the data storage port 310 with the IP address 192.168.1.1 is “300 Mbps” 812, and the total transmitting rate is “540 Mbps” 812.

Next, processing of this computer system will be described.

First, processing for setting an initial value, which is instructed by an administrator of the computer system in this embodiment, in the management information 415 will be described.

FIG. 22 is a flow diagram of initialization processing of the operation management apparatus 400. The CPU 404 executes the initializing program 414 stored in the memory 405 to thereby perform this initialization processing. The CPU 404 receives an initial value of a transmitting rate inputted from the input device 402 (S2201: YES). Then, the CPU 404 updates the management information 415 on the basis of the received initial value (S2202). That is, the CPU 404 sets the received initial value in respective transmitting rates of the management information 415 and sets “0” in respective reception loads. Than, the CPU 404 informs the server 200 of the received initial value of the transmitting rate (S2203). Note that the received initial value of the transmitting rate is referred to as minimum transmitting rate. In addition, in this embodiment, the following description is made assuming that the minimum transmitting rate is “10 Mbps”. However, the minimum transmitting rate, which is the initial value, nay be set in detail for each combination of the IP address 801 of the data storage port 301, an iSCSI initiator, and an iSCSI target.

FIG. 23 is a flow diagram of initialization processing of the server 200. The CPU 203 executes the initializing program 214 stored in the memory 204 to thereby perform this initialization processing. The CPU 203 receives an initial value of a transmitting rate from the operation management apparatus 400 (S2301: YES). Then, the CPU 203 updates the transmitting rate information 215 on the basis of the received initial value (S2302). In other words, the CPU 203 sets the received transmitting rate in respective transmitting rates of the transmitting rate information 215 and sets “0” in respective transmission loads.

A user interface for setting an initial value of a transmitting rate is provided in this way, whereby an administrator can set a detailed transmitting rate taking into account a daily operation schedule.

Next, write processing in the case in which the server 200 writes data in the storage system 300 will be described. Note that it is assumed that an iSCSI session, which is a logical communication path of the iSCSI protocol, is established in advance between the iSCSI initiator of the server 200 and the iSCSI target of the storage system 300. In addition, the iSCSI session is constituted by at least one TCP connection. Therefore, it is assumed that all TCP connections constituting the iSCSI session are established between the iSCSI initiator and the iSCSI target. In addition, this write processing is performed in response to a write request for data from the application program 211.

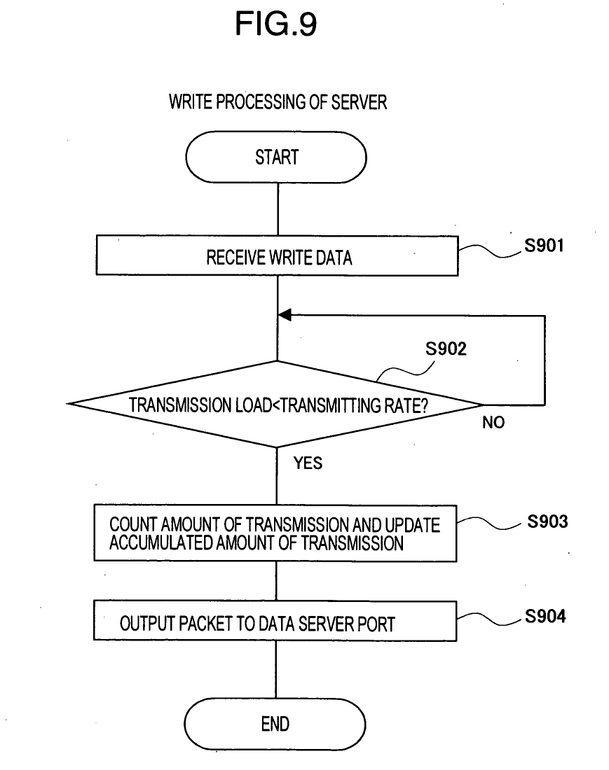

FIG. 9 is a processing flow diagram of write processing of the server 200. The CPU 203 executes the initiator processing program 212 stored in the memory 204 to thereby perform this write processing. The CPU 203 receives write data from the application program 211 (S901). Then, the CPU 203 sets an IP address of the data storage port 301, which is used for transmitting the received write data to the storage system 300, and a destination iSCSI target on the basis of processing of the iSCSI protocol. The CPU 203 judges whether or not a transmission load at present of the set IP address and iSCSI target is lower than the transmitting rate with reference to the transmitting rate information 215 (see FIG. 3) stored in the memory 204 (S902). If the transmission load is lower than the transmitting rate (S902: YES), the CPU 203 counts an amount of data of the write data to update a not-shown accumulated amount of transmission stored in the memory (S903). The accumulated amount of transmission is a total amount of write data which is sent to an iSCSI target within a fixed period (e.g., one minute) in order to measure a transmission load in load measurement processing to be described later. This accumulated amount of transmission is stored in the memory 204 for each IP address of the data storage port 301 to be used and each destination iSCSI target. For example, respective transmission loads are stored by the same table structure as the transmitting rate information 215 shown in FIG. 3.

Then, the CPU 203 reads out an objective accumulated amount of transmission stored in the memory 204 and adds an amount of data of the write data to the read-out accumulated amount of transmission. The CPU 203 sets the total amount for the objective accumulated amount of transmission. Then, the CPU 203 generates a write request message and an iSCSI PDU of the write data and divides the generated iSCSI PDU into several packets to output the packets to the data server port 208 (S904).

On the other hand, if the transmission load is higher than the transmitting rate (S902; NO), the CPU 203 does not perform subsequent processing. The transmission load of the transmitting rate information 215 is updated periodically by load measurement processing to be described later. Therefore, if a state in which the CPU 203 cannot transmit the write data continues, the transmission load automatically becomes smaller than the transmitting rate. Then, the CPU 203 performs the processing of S903 and the subsequent steps only after the transmission load has become smaller than the transmitting rate (S902: YES).

Next, load measurement processing of the data server port 208 of the server 200 will be described.

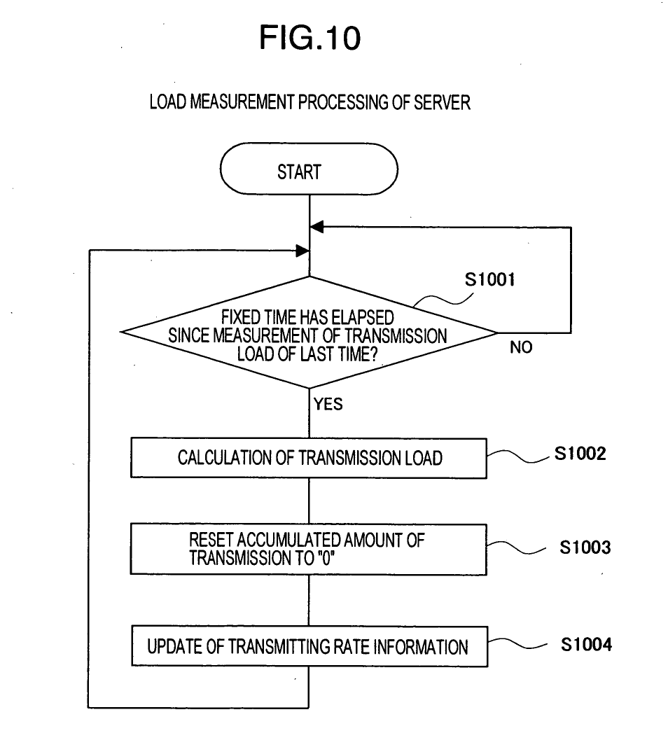

FIG. 10 is a processing flow diagram of the load measurement processing of the server 200. The CPU 203 executes the load measurement program 213 stored in the memory 204 to thereby perform this load measurement processing. The CPU 203 measures a transmission load of the data server port 208 at a predetermined time interval (e.g., one minute) decided in advance. Therefore, the CPU 203 judges whether or not the predetermined time has elapsed since a transmission load was measured last time (S1001). If the predetermined time has not elapsed (S1001: NO), the CPU 203 performs subsequent processing only after the predetermined time has elapsed.

On the other hand, if the predetermined time has elapsed (S1001: YES), the CPU 203 calculates a transmission load for each storage port and each iSCSI target (S1002). In other words, the CPU 203 reads out accumulated amounts of transmission stored in the memory 204, respectively, and divides the read-out accumulated amounts of transmission by the predetermined time to thereby calculate each transmission load (e.g., the number of transmitted bytes per one second). Then, after calculating all transmission loads, the CPU 203 resets the accumulated amounts of transmission stored in the memory 204 to “0” (S1003). Then, the CPU 203 updates the part of each transmission load of the transmitting rate information 215 stored in the memory 204 to a value of the transmission load calculated in S1002 (S1004).

Next, load measurement processing or the data storage ports 301 of the storage system 300 will be described.

FIG. 11 is a processing flow diagram of reception load measurement processing of the storage system 300. The CPU 303 executes the load measurement program 312 stored in the memory 304 to thereby perform this processing. The CPU 303 measures reception loads of the data storage ports 301 at a predetermined time interval (e.g., one minute) decided in advance. Therefore, the CPU 303 judges whether or not the predetermined time has elapsed since a reception load was measured last time (S1101). If the predetermined time has not elapsed (S1101: NO), the CPU 303 performs subsequent processing only after the predetermined time has elapsed.

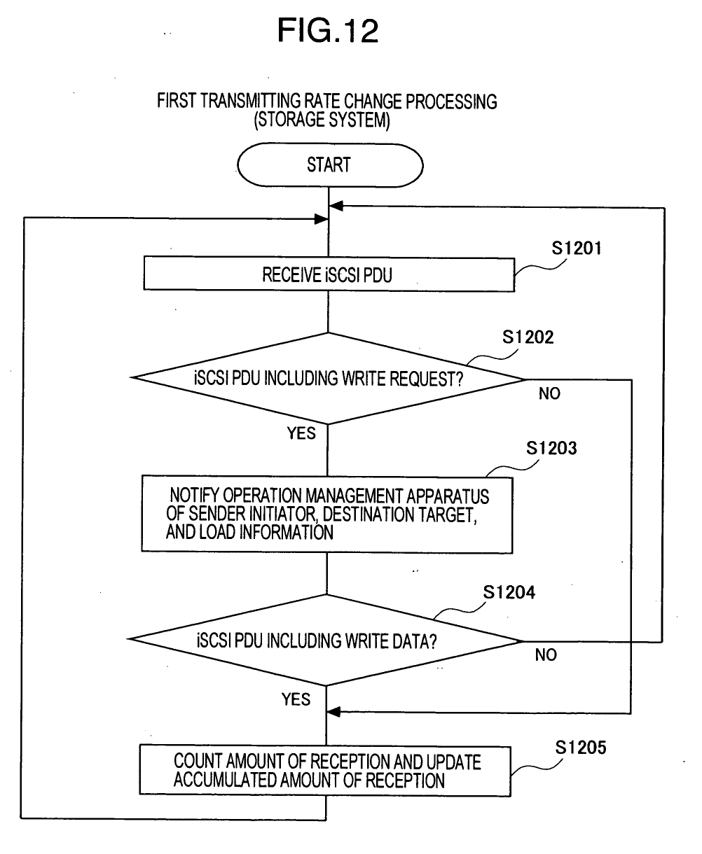

On the other hand, if the predetermined time has elapsed (S1101: YES), the CPU 303 calculates the number of received bytes per a unit time for each data storage port—301, each sender iSCSI initiator, and each destination iSCSI target (S1102). In other words, the CPU 303 reads out each of the accumulated amounts of reception stored in the memory 304 and divides each of the read-out accumulated amounts of reception by the predetermined time to thereby calculate respective reception loads (e.g., the numbers of received bytes per one second). Each of the accumulated amounts of reception is an accumulated amount of received data which is sequentially counted in processing in first transmitting rate change processing to be described later (FIG. 12: S1205). This accumulated amount of reception is a total amount of write data received by the iSCSI target within predetermined period (e.g. one minute) in order to measure a reception load. The accumulated amount of reception is stored in the memory 204 for each IP address of the data storage port 301 to be used, each sender iSCSI initiator, and each destination iSCSI target. For example, the respective reception loads are stored by the same table structure as the load information 316 shown in FIG. 6. Then, after calculating all reception loads, the CPU 303 resets all accumulated amounts of reception stored in the memory 304 to “0” (S1103). Then, the CPU 303 updates reception loads of the load information 316 stored in the memory 304 to values of the calculated reception loads, respectively (S1104).

Next, transmitting rate change processing of the data server port 208 of the server 200 will be described.

First, first transmitting rate range processing will be described. The first transmitting rate change processing is processing for changing a transmitting rate of the data server port 208 as the data storage port 301 of the storage system 300 has received a write request message from the server 200.

FIG. 12 is a processing flow diagram of the storage system 300 in the first transmitting rate change processing. The CPU 303 executes the target processing program 311 stored in the memory 304 to thereby perform this transmitting rate change processing of the storage system 300. First, the CPU 303 receives an iSCSI PDU from the iSCSI initiator of the server 200 via the respective data storage ports 301 (S1201). Then, the CPU 303 judges whether or not a write request message is included in the received iSCSI PDU (S1202). If the iSCSI PDU is an iSCSI PDU including a write request message (S1202: YES), the CPU 303 transmits (notifies) a sender iSCSI initiator, a destination iSCSI target, and an IP address of the data storage port 301 included in the received iSCSI PDU, and the load information 316 (see FIG. 6) stored in the memory 304 to the operation management apparatus 400 via the management storage port 308 (S1203).

Then, the CPU 303 judges whether or not write data is included in the received iSCSI PDU (S1204). If write data is included in the received iSCSI PDU (S1204: YES), the CPU 303 counts an amount of data of the write data. Thc CPU 303 adds the counted amount of data to an objective accumulated amount of reception stored in the memory 304 and sets a total value in the objective accumulated amount of reception (S1204). On the other hand, if the iSCSI PDU is an iSCSI PDU not including a write request message (S1202: NO), that is, if the iSCSI PDU is an iSCSI PDU including only write data, the CPU 303 performs the above-mentioned processing of S1205. In addition, if write data is not included in the received iSCSI PDU (S1204: NO), the CPU 303 returns to the processing of S1201.

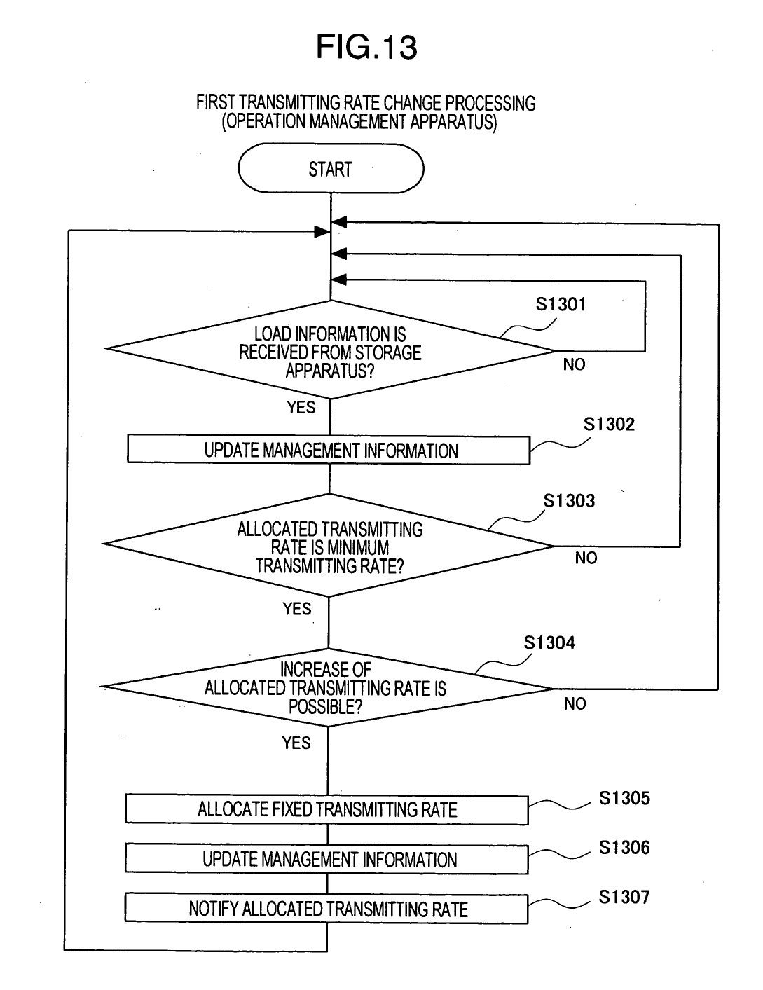

FIG. 13 is a processing flow diagram of the operation management apparatus 400 in the first transmitting rate change processing. The CPU 404 executes the allocation increase program 411 stored in the memory 405 to thereby perform this transmitting rate change processing of the operation management apparatus 400. First, the CPU 404 receives the sender iSCSI initiator, the destination iSCSI target, and the IP address of the data storage port 301, and the load information 316 (see FIG. 6), which are sent by the storage system 300 in S1203 of FIG. 12 the sender iSCSI, via the management port 401 (S1301: YES). Note that the CPU 404 is in a waiting state until the IP addresses and the load information 316 are received from the storage system 300 (S1301: NO). Then, the CPU 404 updates the parts of the reception loads of the management information 415 (see FIG. 8) stored in the memory 405 to numerical values of the load information 316 received from the storage system 300, respectively (S1302).

Then, the CPU 404 judges whether or not a transmitting rate allocated to the received IP address of the storage port 301, sender iSCSI initiator, and destination iSCSI target is a minimum transmitting rate (S1303). Note that, in this embodiment, the minimum transmitting rate is 10 Mbps. Then, if the allocated transmitting rate is the minimum transmitting rate (S1303: YES), the CPU 404 judges whether or not it is possible to increase the minimum transmitting rate to a predetermined transmitting rate (S1304). For example, the CPU 403 refers to the management information 415 stored in the memory 405, and if the total transmitting rate 804 of an objective storage port is equal to or lower than 90 Mbps, the CPU 403 judges that it is possible to change the minimum transmitting rate to the predetermined transmitting rate (e.g., 100 Mbps).

Note that maximum transmitting rates of the respective data storage ports 301 are physically defined according to a device to be used for data transmission (e.g., communication cable). Therefore, for example, The operation management apparatus 400 retains information on the maximum transmitting rates of the respective data storage ports 301 in advance. In changing a transmitting rate to an iSCSI target to which the minimum transmitting rate is allocated, the operation management apparatus 400 may change the transmitting rate to a transmitting rate which does not exceed the maximum transmitting rate of the data storage port 301 used by the iSCSI target. More specifically, in the case in which a maximum transmitting rate of a certain data storage port 301 is 1000 Mbps and the total transmitting rate 804 is 700 Mbps, the operation management apparatus 400 may change a transmitting rate to an iSCSI target, which uses the data storage port 301, from 10 Mbps to 310 Mbps. In this case, if a predetermined value of an increment of the transmitting rate is 400 Mbps, the operation management apparatus 400 sets the transmitting rate after change to 310 Mbps but does not set the transmitting rate to 400 Mbps (because 400 Mbps exceeds a physical limit). In addition, in the case in which it is not preferable in operation to use a transmitting rate as high as the maximum transmitting rate, an arbitrary upper limit value (e.g., 95% of the maximum transmitting rate) may be set as an upper limit value of the transmitting rate of the data storage port 301. The operation management apparatus 400 changes a transmitting rate such that the transmitting rate does not exceed this upper limit value.

Then, if it is possible to change the transmitting rate to the predetermined transmitting rate (S1304: YES), the CPU 404 allocates the predetermined transmitting rate to the objective storage port 301, the sender iSCSI initiator and the destination iSCSI target (S1305). The CPU 404 updates the management information 415 to the allocated predetermined transmitting rate (S1306). The CPU 404 notifies (send) the allocated transmitting rate to the server 200 of the objective sender iSCSI initiator (S1307).

Here, processing of FIG. 13 in the case in which the management information 415 of the operation management apparatus 400 is in the state shown in FIG. 8 and in the case in which the iSCSI initiator “I1” of the server 200₁ has sent a request for writing in the iSCSI target “T2” of the storage system 300 to the data storage port 301 with the IP address 192.168.1.1 will be described specifically. As shown in FIG. 8, a transmitting rate from the iSCSI initiator “I1” to the iSCSI target “T2” in the data storage port 301 with the IP address 192.168.1.1 is “10 Mbps” 821. Therefore, the CPU 404 judges that the transmitting rate is the minimum transmitting rate (S1303: YES). A total of transmitting rates of the data storage port 301 with the IP address 192.168.1.1 is “540 Mbps” 812, which is less than “900 Mbps”. Therefore, the CPU 404 judges that it is possible to increase the transmitting rate (S1304: YES). Then, the CPU 404 updates the objective transmitting rate of the management information 415 from “10 Mbps” 821 to “100 Mbps” and updates the objective total transmitting rate from “540 Mbps” 812 to “630 Mbps” (S1306). The CPU 404 transmits the IP address “192.168.1.1” of the objective data storage port 301, the iSCSI name “T2” of the iSCSI target, and the allocated transmitting rate “100 Mbps” to the server 200₁ having the iSCSI initiator “I1” (S1307). Note that the server 200 updates the part of the objective transmitting rate of the transmitting rate information 215 on the basis of these pieces of information received from the operation management apparatus 400.

Next, second transmitting rate change processing will be described. The second transmitting rate change processing is processing in which the operation management apparatus 400 monitors a reception load of the data storage ports 301 and changes allocation of a transmitting rate periodically on the basis of this reception load.

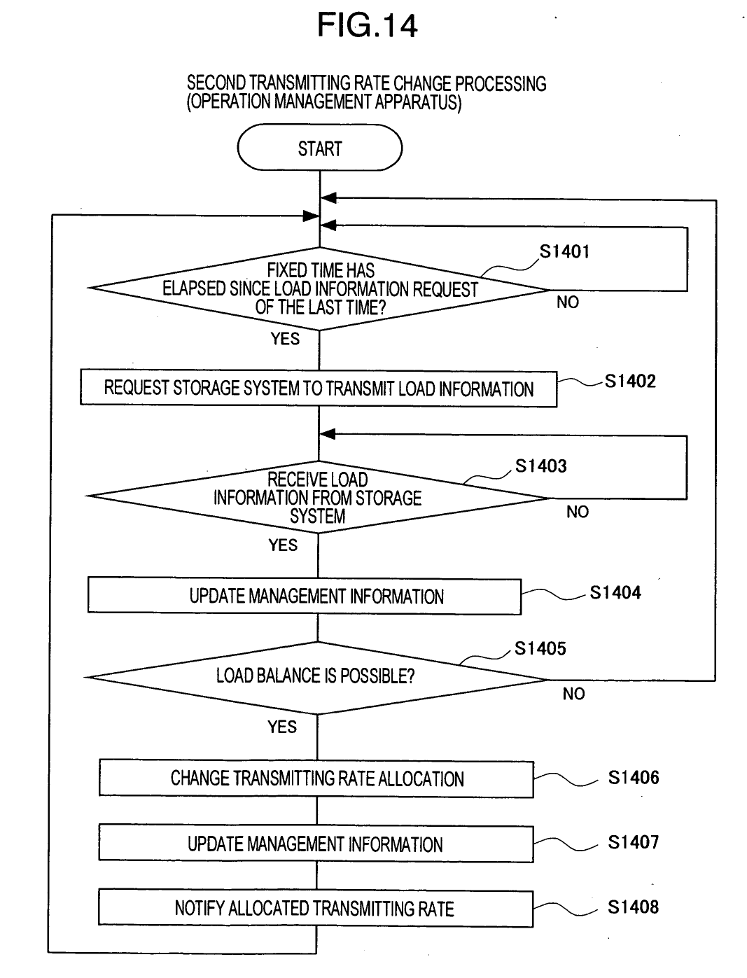

FIG. 14 is a processing flow diagram of the operation management apparatus 400 in the second transmitting rate change processing. The CPU 404 executes the load information request program 412 stored in the memory 405 to thereby perform this transmitting rate change processing of the operation management apparatus 400. The CPU 404 transmits a message, which is used for periodically requesting the storage system 300 to transmit the load information 316 to the CPU 404, via the management port 401 at a predetermined time interval (e.g., one minute) decided in advance. Therefore, the CPU 404 judges whether or not the predetermined time has elapsed since the load information 316 was requested last time (S1401). If the predetermined time has not elapsed (S1401; NO), the CPU 404 performs subsequent processing only after the predetermined time has elapsed.

If the predetermined time has elapsed (S1401: YES), the CPU 404 requests the storage system 300 to transmit the load information 316 (S1402). Then, the CPU 404 receives the load information 316 from the storage system 300 (S1403) and updates the parts of reception loads of the management information 415 stored in the memory 405, respectively, on the basis of the received load information 315 (S1404).

Next, the CPU 404 judges whether or not load balance of the data storage ports 301 is possible (S1405). In other words, the CPU 404 judges whether or not an iSCSI initiator, which accesses a certain iSCSI target through a certain data storage port 301, can access the iSCSI target through another data storage port 301 with a low reception load. For example, the CPU 404 calculates an average value of the total reception loads with reference to a total reception load for each data storage port 301 of the management information 415. Then, if there is the data storage port 301, which has a total reception load larger than (alienated from) this average value by a predetermined value or more, the CPU 404 judges that an object of load balance is present.

For example, in the case of the management information 415 of FIG. 8, an average of the total reception loads 804 is about 366 Mbps from expression (300+200+600)/3. Then, in the case in which the predetermined value is 200 Mbps, since the total reception load of the data storage port 301 with the IP address 192.168.1.3 is 600 Mbps 813, the total reception load is larger than the average value by the predetermined value (200 Mbps) or more. Details of this 600 Mbps 813 are a reception load 300 Mbps 814 from the iSCSI initiator “I2” to the iSCSI target “T3” and a reception load 300 Mbps 815 from the iSCSI initiator “I3” to the iSCSI target “T2” in the data storage port 301 with the IP address 192.168.1.3. Since a “null (blank)” is set in the data storage ports 301 other than the one with the IP address 192.168.1.3 as shown in the figure, the iSCSI initiator “I2” cannot access the iSCSI target “T3”. Thus, the reception load 300 Mbps 814 from the iSCSI initiator “I2” to the iSCSI target “T3” cannot be distributed. On the other hand, concerning the load 300 Mbps 815 from the iSCSI initiator “I3” to the iSCSI target “T2”, the iSCSI initiator “I3” can access the iSCSI target “T2” using the data storage port 301 with the IP address 192.168.1.1 or the IP address 192.168.1.2. Thus, the CPU 404 judges that the load 300 Mbps 815 can be distributed to the other data storage ports 301 (S1405: YES).

Then, if the load balancing is possible (S1405: YES), the CPU 404 changes the transmitting rate such that reception loads are uniformalized as much as possible among the data storage ports 301 (S1406). For example, in the case of the management information 415 of FIG. 8, the CPU 404 refers to total reception loads of the data storage ports 301 with the IP address 192.168.1.1 and the IP address 192.168.1.2 and distributes a predetermined value of load (e.g., 200 Mbps) to the data storage port 303 with a smaller total reception load (IP address 192.168.1.2). In other words, the CPU 404 decreases a transmitting rate from the iSCSI initiator “I3” to the iSCSI target “T2” in the data storage port 301 with the IP address 192.168.1.2 from 300 Mbps 815 to 100 Mbps. Then, the CPU 404 increases a transmitting rate from the iSCSI initiator “I3” to the iSCSI target “T2” in the data storage port 301 with the IP address 192.168.1.2 from 200 Mbps 816 to 400 Mbps by an amount equivalent to the decrease. Consequently, a total transmitting rate of the data storage port 301 with the IP address 192.168.1.3 is changed from 740 Mbps 813 to 540 Mbps, and a total transmitting rate of the data storage port 301 with the IP address 192.169.1.3 is changed from 310 Mbps 817 to 510 Mbps. As a result, the reception loads are distributed among the data storage ports 301.

Then, the CPU 404 updates the parts of transmitting rates of the management information 415 on the basis of the transmitting rates which are changed as described above (S1407). The CPU 404 notifies the objective server 200 of the transmitting rates after update (S1408).

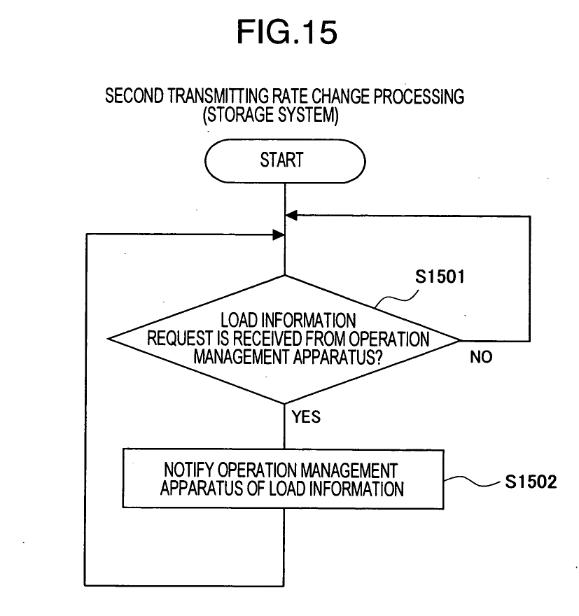

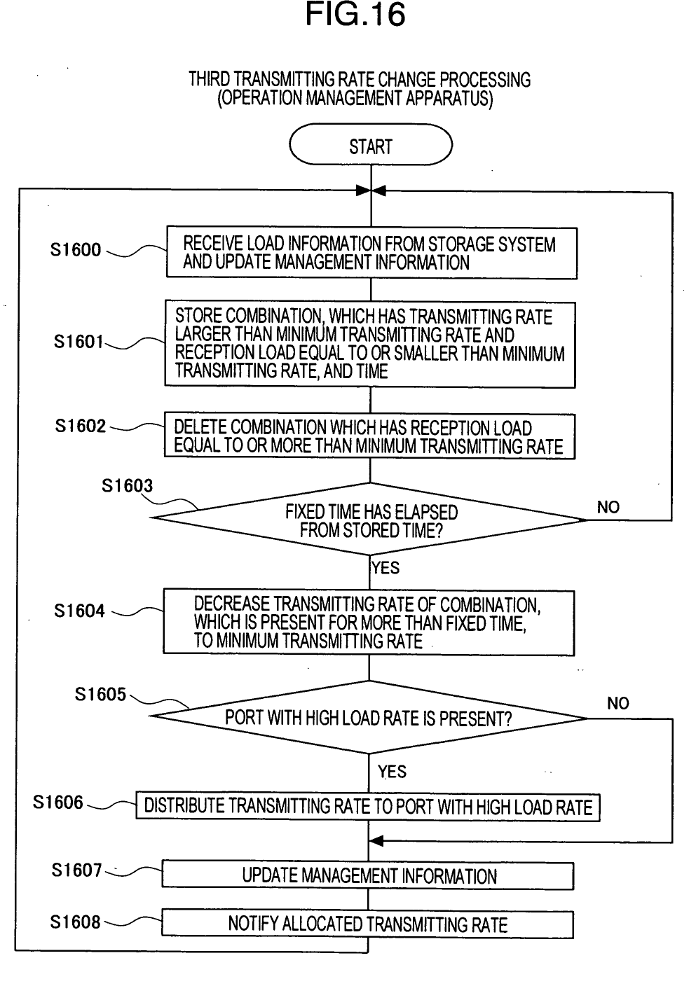

FIG. 15 is a processing flow diagram of the storage system 300 in the second transmitting rate change processing. The CPU 303 executes the load information notification program 313 stored in the memory 304 to thereby perform this transmitting rate change processing of the storage system 300. When a request message for the load information 316 from the operation management apparatus 400 is received via the management storage port 308 (S1501: YES), the CPU 303 transmits the load information 316 stored in the memory 804 to the operation management apparatus 400 (S1502). Note that the CPU 303 is in a waiting state until the request message for the load information 316 from the operation management apparatus 400 is received (S1501: NO).

Next, third transmitting rate change processing will be described. The third transmitting rate change processing is a method with which the operation management apparatus 400 allots a transmitting rate of a combination of an iSCSI initiator, an ISCSI target, and the data storage port 301, which have a low load, to a combination of an iSCSI initiator, an iSCSI target, and the data storage port 310, which have a high load, on the basis of the load information 316 received from the storage system 300.

FIG. 16 is a processing flow diagram of the operation management apparatus 400 in the third transmitting rate change processing. The CPU 404 executes the allocation decrease program 413 stored in the memory 405 to thereby perform this transmitting rate charge processing of the operation management apparatus 400. First, at some timing, the CPU 404 receives the load information 316 from the storage system 300 via the management port 401 and updates a reception load of the management information 413 stored in the memory 405 (S1600). As the timing for receiving the load information 316 from the storage system 300, for example, the reception of the load information 316 in the first transmitting rare change processing (FIG. 13; S1301) or the reception of the load information 316 in the second transmitting rate change processing (FIG. 14: S1403) is possible.

Then, the CPU 404 roads out the updated management information 415 from the memory 405 and extracts all combinations of iSCSI initiators, iSCSI targets, and the data storage ports 301, which have a transmitting rate larger than the minimum transmitting rate and a reception load smaller than the minimum transmitting rate. Thc CPU 404 stores combination identification information for identifying the extracted combination and a time when the load information is received in the memory 405 (S1601). In addition, the CPU 404 reads out the updated management information 415 from the memory 405 and performs the processing of S1601 to thereby delete combination identification information, in which the reception load is updated to the minimum transmitting rate or more, among the pieces of combination identification information, which are already stored in the memory 405, from the memory 405 (S1602). Then, the CPU 404 judges whether or not there is combination identification information, which has remained stored for more than a fixed time from the reception time when the information was stored in the memory, among the pieces of combination identification information stored in the memory (S1603). If there is no combination identification information which has remained stored for more than the fixed time (S1603: NO), the CPU 404 returns to the processing of S1600.

On the other hand, if there is combination identification information which has been stored for more than the fixed time (S1603: YES), the CPU 404 decreases a transmitting rate of the pertinent combination to the minimum transmitting rate (S1604). The, the CPU 404 judges whether or not a combination of an iSCSI initiator, an iSCSI target, and the data storage port 301, which have a load rate higher than a predetermined value, is present with reference to the management information 415 (S1605). The load rate is a ratio of a reception load with respect to a transmitting rate. For example, in the case in which a reception load is 100 Mbps and a transmitting rate is 200 Mbps, the load rate is 50%. If a combination having the load ratio higher than the predetermined value is present (S1605: YES), the CPU 404 allocates the transmitting rate equivalent to the amount decreased in S1604 to a combination having a highest load rate (S1606). Then, the CPU 404 updates the part of the pertinent transmitting rate of the management information 415 on the basis of the transmitting rate changed in S1604 and S1606 (S1607). The CPU 404 notifies the server 200, which includes the iSCSI initiator for which the transmitting rate is changed, of the transmitting rate (S1608).

In the case of the management information 415 shown in FIG. 8, for example, a reception load and a transmitting rate of a combination of the iSCSI initiator “I2” and the iSCSI target “T2” in the data storage port 301 with the IP address 192.168.1.2 are “0/100” 831. In other words, the reception load is 0 Mbps which is less than the minimum transmitting rate, and the transmitting rate is 100 Mbps which is larger than the minimum transmitting rate. Therefore, if this state lasts for a fixed time, the CPU 404 decreases the transmitting rate to 10 Mbps (S1604). Then, the CPU 404 allots this decrease in the transmitting rate of 90 Mbps to a transmitting rate of a highest combination “200/200” 816, which is higher than a predetermined load rate (e.g., 70%), in the data storage port 301 with the IP address 192.168.1.2. In other words, the CPU 404 increases the transmitting rate of the combination by 90 Mbps to change it to “200/290” (S1606).

According to the first embodiment described above, in writing data in the storage system 300, the server 200 transmits the data in accordance with a transmitting rate allocated to the operation management apparatus 400. Consequently, congestion in the data storage ports 301 can be prevented. In addition, since a reduction in a window size due to occurrence of congestion can be avoided, a stable throughput can be provided.

Next, a second embodiment will be described. In this embodiment, unlike the first embodiment, an initial value of a transmitting rate is set to “0 Mbps”.

A configuration of a computer system in this embodiment is the same as that in the first embodiment shown in FIGS. 1 to 8. However, the second embodiment is different from the first embodiment in that “0 Mbps” is set to an allocated transmitting rate of the transmitting rate information 215 shown in FIG. 3 and the management information 415 shown in FIG. 8. as an initial value rather than a minimum transmitting rate (e.g., 10 Mbps). In addition, in the first embodiment, the respective CPUs of the operation management apparatus 400 and the server 200 execute the initializing program 414 and the initializing program 214 to allocate a minimum transmitting rate of “10 Mbps” in advance such that the server 200 starts writing. However, in this embodiment, the respective initializing programs 214 and 414 are executed to set an initial value of a transmitting rate to “0 Mbps”. In other words, a state of initial values for the management information 415 and the transmitting rate information before the server 200 issues a write request is set as “0/0”.

In this embodiment, since the transmitting rate in the initial state is “0 Mbps”, it is necessary to allocate a transmitting rate, which is required by the server 200 to start writing, to the data server port 208 anew. Two kinds of processing for requesting allocation of a transmitting rate will be hereinafter described.

A first transmitting rate allocation request processing is processing in which the server 200 requests the operation management apparatus 400 to allocate a transmitting rate of the data server port 208 prior to transmission of an iSCSI PDU of a write request.

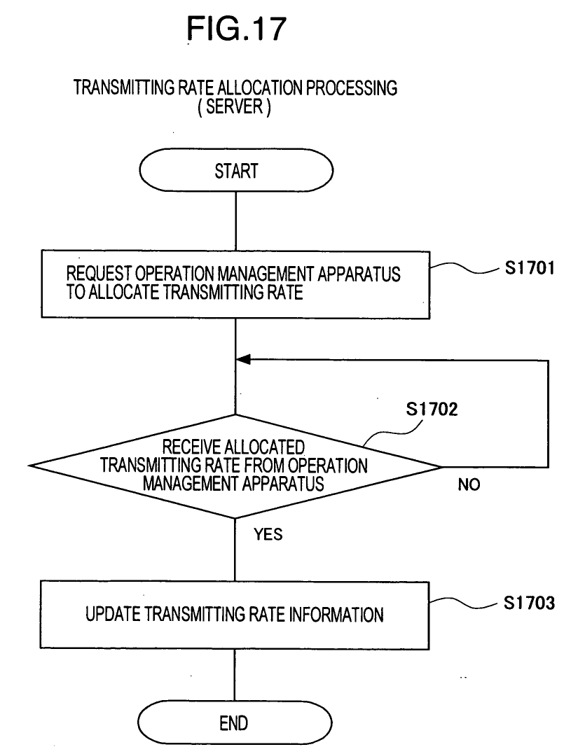

FIG. 17 is a processing flow diagram of processing performed by the server 200 in the first transmitting rate allocation request processing. The CPU 203 executes the initiator processing program 212 stored in the memory 204 to thereby perform this allocation request processing. The CPU 203 designates the data storage port 301 to be used, a sender iSCSI initiator, and a destination iSCSI target and requests the operation management apparatus 400 to allocate a transmitting rate of the data server port 208 (S1701). Then, the CPU 203 receives a predetermined transmitting rate (e.g., 100 Mbps) from the operation management apparatus 400 (S1702: YES). Note that the CPU 203 is in a waiting state until a transmitting rate is received from the operation management apparatus 400 (S1702: NO). Then, the CPU 203 updates transmitting rates of the objective data storage port 301 and the iSCSI target of the transmitting rate information 215 stored in the memory (S1703). Consequently, the predetermined transmitting rate is allocated to the data server port 208 of the server 200 to allow writing of data.

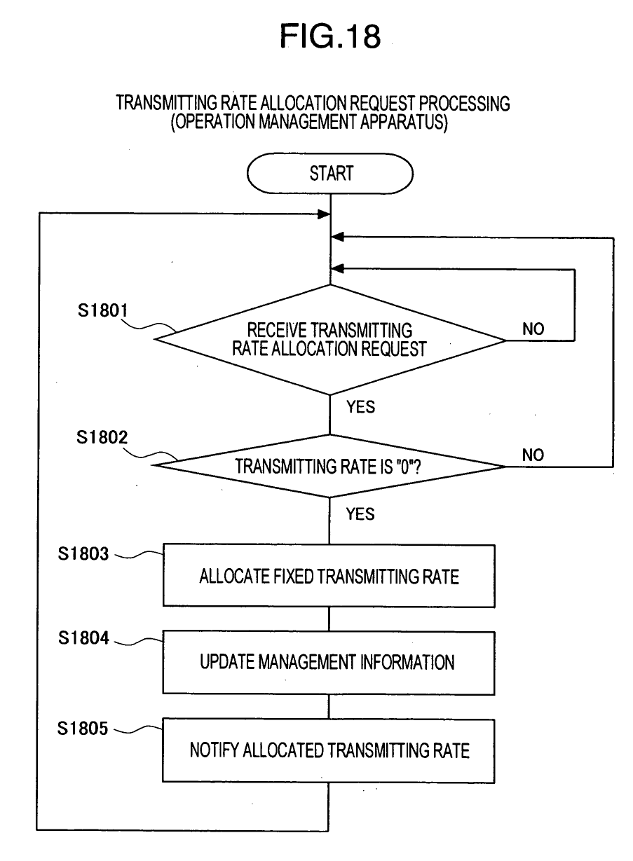

FIG. 18 is a processing flow diagram of processing performed by the operation management apparatus 400 in the first transmitting rate allocation request processing. The CPU 404 executes the allocation increase program 411 stored in the memory 405 to thereby perform this allocation request processing. The CPU 404 receives an allocation request for a transmitting rate from the server 200 (S1801: YES). Note that the CPU 404 is in a waiting state until an allocation request is received from the server 200 (S1801; NO). Then, the CPU 404 judges whether or not “0 Mbps” is set in a transmitting rate of a combination of data storage port 301 to be used, a sender iSCSI initiator, and a destination iSCSI target, which are included in the allocation request received from the server 200 with reference to the management information 415 (S1802). If “0 Mbps” is set in the transmitting rate (S1802: YES), the CPU 404 allocates a predetermined transmitting rate to the combination (S1803). The CPU 404 updates the part of the objective transmitting rate of the management information 415 (S1804). Then, the CPU 404 notifies the server 200, which sent the allocation request, of the allocated transmitting rate (S1805). On the other hand, if a numerical value other than “0 Mbps” is set in the transmitting rate (S1802: NO), the CPU 404 returns to the processing of S1801 without performing allocation of a transmitting rate.

Next, second transmitting rate allocation request processing will be described. The second transmitting rate allocation request processing in processing for requesting allocation of a transmitting rate of the data server port 208 as the CPU 303 of the storage system 300 has received an iSCSI PDU of a write request via the data storage ports 301. The CPU 303 executes the target processing program 311 stored in the memory 304 to thereby perform the processing of the storage system 300 in this second transmitting rate allocation request processing. Then, the CPU 303 performs the same processing as FIG. 12. In addition, processing of the operation management apparatus 400 in this second transmitting rate allocation request processing is the same processing FIG. 18. Note that, in the second transmitting rate allocation request processing, a transmitting rate allocation request is received from the storage system 300 in S1801.

According to the first transmitting rate allocation request processing or the second transmitting rate allocation request processing, a transmitting rate for writing is allocated anew to a combination of an iSCSI initiator, an iSCSI target, and the data storage port 301, for which a transmitting rate of the management information 415 of the operation management apparatus 400 is “0 Mbps”. Consequently, a transmitting rate of the transmitting rate information 215 of the server 200 is updated to a numerical value other than “0 Mbps”.

In addition, in this embodiment, in the case in which there is no access to a certain combination of an iSCSI initiator, an iSCSI target, and the data storage port 301 from the server 200 for a predetermined time, the operation management apparatus 400 performs processing for decreasing allocation or a transmitting rate for the combination. In other words, the CPU 404 executes the allocation decrease program 413 stored in the memory 405 to thereby perform this processing of the operation management apparatus 400. The CPU 404 decreases a pertinent transmitting rate to “0 Mbps”. Then, the CPU 404 allocates a transmitting rate equivalent to the decreased amount to a transmitting rate of a combination of an iSCSI initiator and an iSCSI target which have a load rate higher than a predetermined load rate in a the pertinent data storage port 301.

Note that this transmitting rate allocation decrease processing of the operation management apparatus 400 is the same processing as FIG. 16. However, the CPU 404 stores a combination, in which a reception load is “0 Mbps” rather than a minimum transmitting rate, in the memory 405 in S1601. In addition, the CPU 404 removes a combination, in which a transmission load is larger than “0 Mbps”, from the memory 405 in S1602. In addition, the CPU 404 decreases a transmitting rate of a combination, which is stored in the memory for a fixed time, to “0 Mbps” in S1604.

For example, in FIG. 8, in the data storage port 301 with the IP address 192.168.1.2 involved in writing from the iSCSI initiator “I2” to the iSCSI target “T2”, a reception load is “0 Mbps” and a transmitting rate is “100 Mbps” 831. If this state lasts for a fixed time, the CPU 404 decreases the transmitting rate to “0 Mbps”. Moreover, the CPU 404 changes a transmitting rate from the iSCSI initiator “I3” with a high load rate to the iSCSI target “T2” from “200 Mbps” 816 to “300 Mbps”.

According to the second embodiment, it is unnecessary to allocate a transmitting rate to a combination of an iSCSI initiator and an iSCSI target, which do not perform write processing, in advance. Thus, it is made possible to allocate a larger transmitting rate to other combinations of iSCSI initiators and iSCSI targets.

Next, a third embodiment will be described. In the first and the second embodiments, the method of controlling a transmitting rate of the data server port 208 in the processing for writing data from the server 200 to the storage system 300 is described. In this embodiment, an embodiment for controlling a transmitting rate of the data storage ports 301 in the case in which the server 200 reads data from the storage system 300 will be described.

A configuration of a computer system to which this embodiment is applied is the same as that in the first embodiment shown in FIGS. 1 to 8 except the points described below. First, programs and data stored in the memory 304 of the storage system 300 of this embodiment are different from these shown in FIG. 4 described in the first embodiment in the following points. The target processing program 311 is a program for adjusting an amount of data, which the data storage ports 301 transmit in a unit time, on the basis of the operation management apparatus 400 and requesting the operation management apparatus 400 to allocate a transmitting rate to the data storage ports 301. The CPU 303 executes the target processing program 311 stored in the memory 304 to thereby adjust an amount of transmit data of the data storage ports 301 and request the operation management apparatus 400 to allocate a transmitting rate.

The load measurement program 312 is a program for measuring the numbers of transmitted bytes per a unit time of the respective data storage ports 301. The CPU 303 executes the load measurement program 312 stored in the memory 304 to thereby measure the numbers of transmitted bytes of the data storage ports 301.

The load information 316 has the same table configuration as the load information 316 shown in FIG. 6. However, the load information 316 represents a transmission load of the data storage ports 301 rather than a reception load. In addition, the iSCSI name 602 of the sender iSCSI initiator in the first embodiment is an iSCSI name of a destination iSCSI initiator in this embodiment. In addition, the iSCSI name 603 of the destination iSCSI target in the first embodiment is an iSCSI name of a sender iSCSI target in this embodiment.

In addition, the memory 304 of the storage system 300 of this embodiment includes transmitting rate information which is not present in the first embodiment. This transmitting rate information has the same configuration as the management information 415 stored in the memory of the operation management apparatus 400 illustrated in FIG. 8. However, this transmitting rate represents transmission loads of the data storage ports 301 and allocated transmitting rates. Further, the iSCSI name 802 of the sender iSCSI initiator in the first embodiment is an iSCSI name of a destination iSCSI initiator in this embodiment. Moreover, the iSCSI name 803 of the destination iSCSI target in the first embodiment is an iSCSI name of a sender iSCSI target in this embodiment.

The initializing program 314 is a program for initializing information, which is managed in the storage system 300, such as the load information 316 and the transmitting rate information. Processing at the time when an initial value of a transmitting rate is notified from the operation management apparatus 400 is the same as the processing in FIG. 23 described in the first embodiment. In addition, initialization processing of the operation management apparatus 400 is the same as that in FIG. 22. However, the operation management apparatus 400 notifies the storage system 300 of a transmitting rate (S2302).

In addition, in this embodiment, the management information 415 stored in the memory of the operation management apparatus 400 has the same configuration as the structure shown in FIG. 8. However, this management information 415 represents transmission loads of the data storage ports 301 and allocated transmitting rates. Further, the iSCSI name 802 of the sender iSCSI initiator in the first embodiment is an iSCSI name of a destination iSCSI initiator in this embodiment. Moreover, the iSCSI name 803 of the destination iSCSI target in the first embodiment is an iSCSI name of a destination iSCSI target in this embodiment.

Next, respective kinds of processing of this computer system will be described.

As in the first embodiment, it is assumed that an iSCSI session, which is a logical communication path of the iSCSI protocol, is established in advance between the iSCSI initiator of the server 200 and the iSCSI target of the storage system 300. In addition, it is assumed that all TCP connections constituting the iSCSI session are also established.

First, processing in the case in which the storage system 300 transmits read data is the same as the processing which is performed by executing the initiator processing program 212 in the processing of FIG. 9. Note that, in this embodiment, the CPU 303 executes the target processing program 311 stored in the memory 304 to thereby perform the processing. In addition, in the case in which the storage system 300 transmits read data, processing for measuring a transmission load by executing the load measurement program 312 is the same as the processing for measuring a transmission load by executing the load measurement program 213 in FIG. 10.

Next, processing in the case in which the server 200 reads data from the storage system 300 will be described. The server 200 reads data according to on a of two methods described below.

A first method is a method with which the server 200 requests the operation management apparatus 400 to allocate a transmitting rate of the data storage ports 301 before the server 200 transmits an iSCSI PDU of a read request to the storage system 300. Processing in this case is the same as the processing in FIG. 17. However, allocation of a requested transmitting rate is allocation to the data storage ports 301 of the storage system 300. In addition, processing of the operation management apparatus 400 in this case is the same as the processing in FIG. 18. However, the operation management apparatus 400 notifies the storage system 300 of the allocated transmitting rate in S1805.

A second method is a method with which the storage system 300 requests allocation of a transmitting rate of the data storage ports 301 as the storage system 300 has received an iSCSI PDU of a read request from the server 200 via the data storage ports 301.

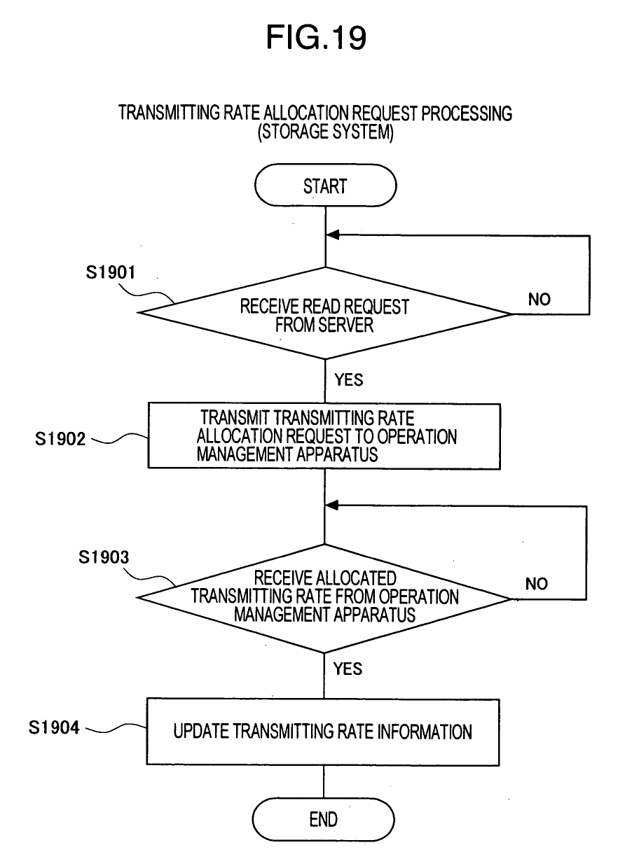

FIG. 19 is a processing flow diagram of processing of the storage system 300 in the second method. The CPU 303 executes the target processing program 311 stored in the memory 304 to thereby perform this processing. First, the CPU 303 receives an iSCSI PDU of a read request from the server 200 (S1901). The CPU 303 transmits a transmitting rate allocation request, which includes a sender iSCSI initiator of the read request, a destination iSCSI target of the read request, the data storage ports 301, and the load information 316 stored in the memory 304, to the operation management apparatus 400 (S1902). Then, the CPU 304 receives an allocated transmitting rate from the operation management apparatus 400 (S1903). The CPU 304 updates the part of an objective transmitting rate of the transmitting rate information 316 stored in the memory 304 (S1904).

Processing of the operation management apparatus 400 in the second method is the same as the processing shown in FIG. 18. However, the operation management apparatus 400 receives an allocation request for a transmitting rate from the storage system 300 in S1801, and notifies the storage system 300 of the allocated transmitting rate in S1805.

According to one of the methods, a transmitting rate, which is used by the data storage ports 301 to transmit read data, is allocated anew to a combination of an iSCSI initiator, an iSCSI target, and the data storage port 301 with a transmitting rate of “0 Mbps” in the management information 415 stored in the memory 405 of the management apparatus 400.

Next, a method with which the operation management apparatus 400 monitors transmission loads of the data storage ports 301 and changes allocation of a transmitting rate periodically according to the transmission loads will be described.

Processing of the operation management apparatus 400 in the first transmitting rate change processing is the same as the processing shown in FIG. 14. However, the transmission loads of the data storage ports 301 are stored in the load information 316 stored in the memory 304. In addition, the operation management apparatus 400 notifies the storage system 300 of a transmitting rate in S1408. Further, in the description of the first embodiment, as an example, a reception loads are distributed among the data storage ports 301 by the processing of FIG. 14. However, in this embodiment, it is possible to distribute transmission loads among the data storage ports 301.

Processing of the storage system 300 in the first transmitting rate change processing is the same as the processing shown in FIG. 15. However, a transmission load of the data storage ports 301 is stored in the load information 316 stored in the memory 304 which is notified to the operation management apparatus 400.

Next, second transmitting rate change processing will be described. This second transmitting rate change processing is processing for allotting a transmitting rate of a combination of an iSCSI initiator, an iSCSI target, and the data storage port 301 with a low load to a combination of an iSCSI initiator, an iSCSI target, and the data storage port 301 with a high transmission load. Processing of the operation management apparatus 400 of the second transmitting rate change processing is the same as the processing shown in FIG. 16. However, a transmission load of the data storage ports 301 is stored in the load information 316 of the storage system 300. in addition, the operation management apparatus 400 notifies the storage system 300 of an allocated transmitting rate in S1608. Further, in the description of the first embodiment, as an example, allocation of a transmitting rate of the data server port 208 is changed by the processing of FIG. 16. However, in this embodiment, it is possible to change allocation of transmitting rates of the data storage ports 301.

According to the third embodiment described above, when the server 200 reads data from the storage system 300, the server 200 or the storage system 300 can request change of a transmitting rate of the data storage port 301 allocated to an iSCSI target to which the data is sent. In addition, the operation management apparatus 400 performs the same processing as the second transmitting rate change processing described in the first embodiment. Consequently, a transmitting rate of the data storage ports 301 can be changed according to a transmission load to perform load balance among the data storage ports 301 and utilize performance of the data storage ports 301 effectively.

Next, a fourth embodiment will be described. In this embodiment, an embodiment for controlling a transmitting rate of the data storage ports 301 will be described as in the third embodiment. In other words, in this embodiment, processing in the case in which data transfer (remote copy) is performed among plural storage systems will be described.

A configuration of a computer system to which this embodiment is applied is the same as that in the third embodiment except the points described below.

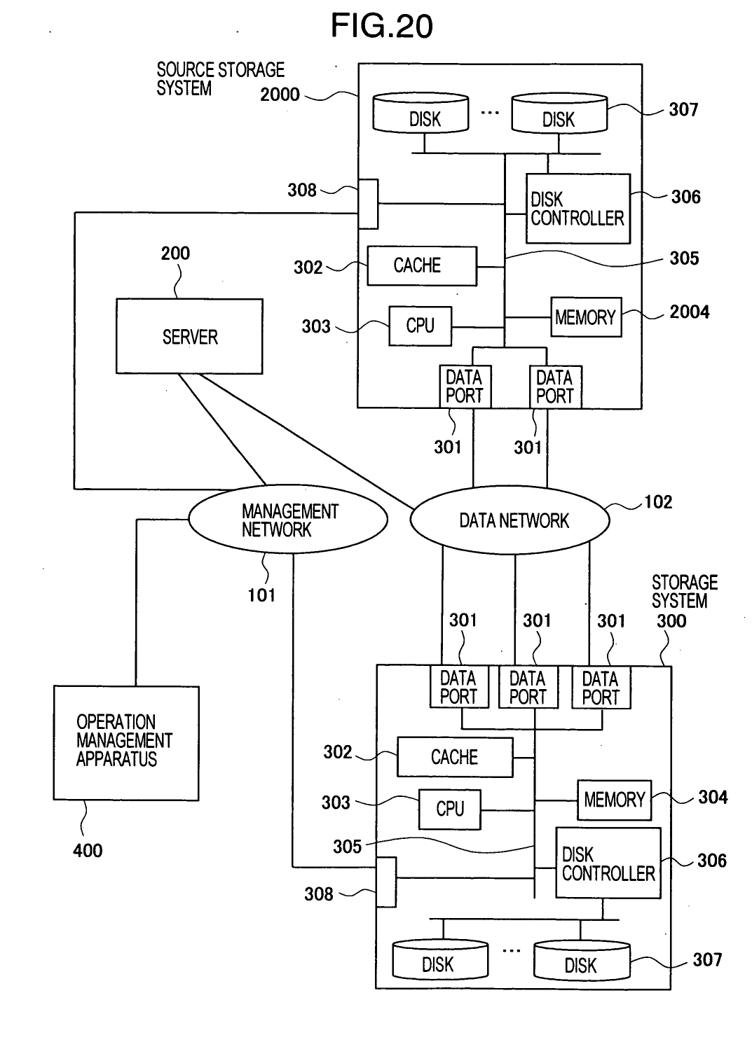

FIG. 20 is a schematic diagram or the computer system to which the fourth embodiment of the present invention is applied. As shown in the figure, the computer system of this embodiment includes a server 200, a storage system 300, an operation management apparatus 400, a data network 102, a management network 101, and a source storage system 2000. Configurations of the apparatuses other than the source storage system 2000 of this computer system are the same as these shown in FIG. 1 to which the third embodiment is applied. The source storage system 2000 receives a write request for data from the server 200 and stores write data in the disk 307. Then, for backup at the time of failure or the like, the source storage system 2000 remotely copies the write data received from the server 200 to the storage system 300 via the data network 102. In addition, a hardware configuration of the storage system 2000 is the same as the storage system 300.

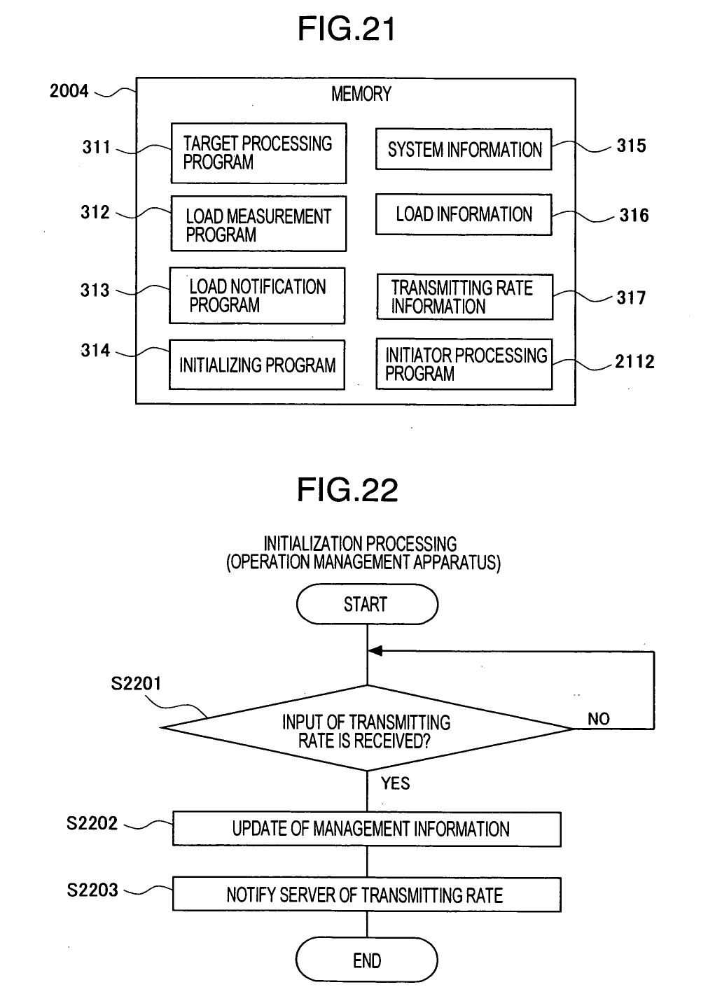

FIG. 21 shows programs and data stored in a memory 2004. The programs and data stored in the memory 2004 are different from those stored in the memory 304 of the third embodiment in that the programs and data include an initiator processing program 2112. The initiator processing program 2112 is a program which is the same as the initiator processing program 212 stored in the memory 204 of the server 200 in the first embodiment. That is, the CPU 203 of the source storage system 2000 executes the initiator processing program 2112 to thereby request the operation management apparatus 400 to allocate a transmitting rate of the data storage ports 301 in the storage system 2000.

In the remote copy from the source storage system 2000 to the storage system 300, the source storage system 2000 writes data in the storage system 300. Therefore, the processing in which the source storage system 2000 writes data in the storage system 300 is the same as the processing in which the server 200 writes data in the storage system 300 in the first or the second embodiment. However, whereas the operation management apparatus 400 notifies the server 200 of a transmitting rate in the first or the second embodiment, the operation management apparatus 400 notifies the source storage system 2000 of a transmitting rate in this embodiment.

According to the fourth embodiment described above, the source storage system 2000 can transmit (remotely copy) write data to the storage system 300 at the transmitting rate notified from the operation management apparatus 400. Consequently, congestion in the data storage ports 301 of the storage system 300, which is a copy destination, can be prevented to provide a stable throughput.

Note that, in this embodiment, management of a transmitting rate or the data storage ports 301 held by the source storage system 2000, which becomes a transmission side of data, is changed to management under the operation management apparatus 400. However, conversely, it is also possible to control a transmitting rate in the data storage ports 301 held by the storage system 300, which becomes a reception side of data, in the same manner as the third embodiment. In this case, the server 200 in the third embodiment serves as the source storage system 2000.

Note that the present invention is not limited to the above-mentioned embodiments, and various modifications are possible within the scope of the present invention. For example, for convenience of explanation, the first, the second, the third, and the fourth embodiments have been described. However, the present invention may be arbitrary combinations of these embodiments. For example, by combining the first embodiment and the third embodiment, the operation management apparatus 400 can effectively utilize the data storage ports 301 of the storage system 300 as reception ports or transmission ports on the basis of a transmission load and a reception load. Note that, since the full duplex communication is performed in the IP SAN, a maximum value of the transmitting rate can also be set independently for transmission and reception and to a full physical limit. Therefore, in the case in which a physical limit of a transmitting rate is, for example, 1000 Mbps, the operation management apparatus 400 can set a maximum transmitting rate in outputting data and a maximum transfer rate in receiving data to 1000 Mbps, respectively, for one data storage port 301.

In addition, in the embodiments, a protocol for performing transmission and reception or data in the IP SAN is described an iSCSI as an example. However, the present invention is not limited to this, and protocols other than the iSCSI protocol may be used.

In the present invention, congestion of ports in a storage system can be prevented.

1. A load balancing method for a computer system including: a computer; a storage system which stores data to be accessed by the computer via a network; and a management apparatus which manages the computer and the storage system, the load balancing method comprising:
a measurement step of measuring reception loads of respective storage ports provided in a storage system;
an allocation changing step of changing a transmitting rate of a computer port provided in a computer, which is allocated for each of the storage ports, on the basis of the reception loads of the respective storage ports measured in the measurement step; and
a transmission step of transmitting data to the respective storage ports of the storage system at a transmitting rate in a range not exceeding the transmitting rate for each of the storage ports changed in the allocation changing step.

2. A load balancing method according to claim 1, wherein,
the allocation changing step judges whether or not the transmitting rate, which is allocated for each of the storage ports, is a predetermined minimum transmitting rate, and if the transmitting rate, which is allocated for each of the storage ports, is the minimum transmitting rate, increases the minimum transmitting rate.

3. A load balancing method according to claim 1, wherein,
the allocation changing step judges whether or not a transmitting rate of a low load rate, which is larger than a predetermined minimum transmitting rate and has a ratio of a reception load of a storage port with respect to the transmitting rate smaller than a predetermined value, is present in the transmitting rates of the respective storage ports, and if the transmitting rate of a low load rate is present, decreases the transmitting rate.

4. A load balancing method according to claim 1, further comprising an allocation receiving step of receiving input of the transmitting rate to be allocated for each of the storage port.

5. A load balancing method for a computer system including: a computer; a storage system which stores data to be accessed by the computer via a network; and a management apparatus which manages the computer and the storage system, the load balancing method comprising:
a measurement step of measuring transmission loads of respective storage ports provided in a storage system;
an allocation changing step of changing a transmitting rate, which is allocated to each of the storage ports, on the basis of the transmission loads of the respective storage ports measured in the measurement step; and
a transmission step of transmitting data to a computer port provided in the computer at a transmitting rate in a range not exceeding the transmitting rate for each of the storage ports changed in the allocation changing step.

6. A load balancing method according to claim 5, wherein,
the allocation changing step judges whether or not the transmitting rate of each of the storage ports is a predetermined minimum transmitting rate, and if the transmitting rate of the storage port is the minimum transmitting rate, increases the minimum transmitting rate.

7. A load balancing method according to claim 5, wherein,
the allocation changing step judges whether or not a transmitting rate of a low load rate, which is larger than a predetermined minimum transmitting rate and has a ratio of a transmission load of a storage port with respect to the transmitting rate smaller than a predetermined value, is present in the transmitting rates of the respective storage ports, and if the transmitting rate of a low load rate is present, decreases the transmitting rate.

8. A load balancing method according to claim 5, further comprising an allocation receive step of receiving input of transmitting rates to be allocated to the respective storage ports.

9. A load balancing method according to claim 1, further comprising:
a transmission load measurement step of measuring transmission loads of the respective storage ports provided in the storage system;
a transmission load allocation changing step of changing the transmitting rate allocated to each of the storage ports on the basis of the transmission loads of the respective storage ports measured in the transmission load measurement step; and
a transmission step of transmitting data to the computer port provided in the computer at a transmitting rate in a range not exceeding the transmitting rate of each of the storage ports changed in the transmission load allocation changing step.

10. A load balancing method for a storage system including: a first storage system, a second storage system which is connected to the first storage system via a network; and a management apparatus which manages the first storage system and the second storage system, the load balancing method comprising:
a measurement step of measuring a reception load of each of second ports provided in the second storage system;
an allocation changing step of changing a transmitting rate of a first port provided in the first storage system, which is allocated for each of the second ports, on the basis of the reception loads of the second ports measured in the measurement step; and
a transmission step of transmitting data to each of the second ports of the second storage system at a transmitting rate in a range not exceeding the transmitting rate for each of the second ports changed in the allocation changing step.

11. A computer system comprising:
a computer;
a storage system which stores data to be accessed by the computer via a network; and
a management apparatus which manages the computer and the storage system, wherein,
the storage system comprises:
a measuring means which measures reception loads of respective storage ports provided in the storage system;
a storing means which stores the reception loads of the respective storage ports measured by the measurement means; and
a transmitting means which transmits the reception loads of the respective storage ports stored in the storing means to the management apparatus, wherein,
the management apparatus comprises:
a receiving means which receives the reception loads of the respective storage ports from the storage system;
an allocation changing means which changes a transmitting rate of a computer port provided in the computer, which is allocated for each of the storage ports, on the basis of the reception loads received by the receiving means; and
a transmitting means which transmits the transmitting rate of the computer port changed by the allocation changing means to the computer, and wherein,
the computer comprises:
a receiving means which receives the changed transmitting rate of the computer port from the managing apparatus; and
a transmitting means which transmits data to the respective storage ports of the storage system at a transmitting rate in a range not exceeding the changed transmitting rate received by the receiving means.

12. A computer system comprising:
a storage system which stores data to be accessed by a computer via a network; and
a management apparatus which manages and the storage system, wherein,
the storage system comprises:
a measuring means which measures transmission loads of respective storage ports provided in the storage system;
a storing means which stores the transmission loads of the respective storage ports measured by the measurement means;
a load transmitting means which transmits the transmission loads of the respective storage ports stored in the storing means to the management apparatus;
a receiving means which receives changed transmitting rates of the respective storage ports from the management apparatus; and
a data transmitting means which transmits data to the computer system at a transmitting rate in a range not exceeding the changed transmitting rates received by the receiving means, wherein,
the management apparatus comprises:
a receiving means which receives the transmission loads of the respective storage ports from the storage system;
an allocation changing means which changes a transmitting rate, which is allocated to each of the storage ports, on the basis of the transmission loads received by the receiving means; and
a transmitting means which transmits the transmitting rate of each of the storage ports changed by the allocation changing means to the storage system.

13. A program which, in a computer system comprising a computer, a storage system which stores data to be accessed by the computer via a network, and a management apparatus which manages the computer and the storage system, is stored in a storage medium in order to perform load balance of storage ports provided in the storage system, the program comprising:
in the management apparatus,
a reception step of receiving reception load of the respective storage ports from the storage system;
an allocation changing step of changing a transmitting rate of a computer port provided in the computer, which is allocated for each of the storage ports of the storage system, on the basis of the received reception loads; and
a transmission step of transmitting the changed transmitting rate for each of the storage ports to the computer.

14. A load balancing method for a computer system comprising: a computer; a storage system which stores data to be accessed by the computer via a network; and a management apparatus which manages the computer and the storage system, the load balancing method comprising:
a reception load balancing step; and
a transmission load balancing step, wherein,
the reception load distribution step further comprises:
an allocation reception step of receiving input of a transmitting rate of a computer port provided in the computer which is allocated for each of storage ports provided in the storage system;
a measurement step of measuring reception loads of the respective storage ports provided in the storage system;
an allocation changing step of changing a transmitting rate of a computer port, which is allocated for each of the storage ports, on the basis of the reception loads of the respective storage ports measured in the measurement step; and
a transmission step of transmitting data to the respective storage ports of the storage system at a transmitting rate in a range not exceeding the transmitting rate, which is allocated to each of the storage ports, changed in the allocation changing step, wherein,
the allocation changing step judges whether or not the transmitting rate allocated for each of the storage ports is a predetermined minimum transmitting rate, and if the transmitting rate allocated for each of the storage ports is the minimum transmitting rate, increases the minimum transmitting rate, wherein,
the transmission load balancing step further comprises:
a transmission load measurement step of measuring transmission loads of the respective storage ports provided in the storage system;
a transmission load allocation changing step of changing the transmitting rate, which is allocated to each of the storage ports, on the basis of the transmission load of the respective storage port measured in the transmission load measurement step; and
a transmission step of transmitting data to the computer port provided in the computer at a transmitting rate in a range not exceeding the transmitting rate for each of the storage ports changed in the transmission load allocation changing step.
